(19) United States
(12) Patent Application Publication
(10) Pub. No.: US 2025/0156802 A1
(43) Pub. Date: May 15, 2025

(54) COMPUTER ARCHITECTURE FOR DISPATCH PLATFORM MODIFICATION

(71) Applicant: SABAVA LLC, Chattanooga, TN (US)

(72) Inventor: Vahid Disfani, Chattanooga, TN (US)

(21) Appl. No.: 18/941,601

(22) Filed: Nov. 8, 2024

Related U.S. Application Data
(60) Provisional application No. 63/597,800, filed on Nov. 10, 2023.

(51) Int. Cl. G06Q 10/0835; G06Q 10/04

(52) U.S. Cl. CPC G06Q 10/08355; G06Q 10/04

(57) ABSTRACT

A server receives an input representing a new truck for addition to a set of load-truck matches stored in a match data repository. The server transforms the input into new truck data. The server generates a new load-truck match matching the new truck to at least one load based on the new truck data, the set of load-truck matches, and a set of global constraints. The server generates an output of multiple new edges for manual review. The output indicates information associated with each of the multiple new edges. The server transmits the output to the client device for display via the graphical user interface. The server receives an indication of a selection of one of the multiple new edges or a rejection of the new edges. The server adjusts the set of load-truck matches stored in a match data repository based on the indication.

### PRIORITY CLAIM

This application claims priority to U.S. Provisional Patent Application No. 63/597,800, filed on Nov. 10, 2023, and titled “AI Dispatch Platform,” the entirety of which is incorporated herein by reference.

### TECHNICAL FIELD

Embodiments pertain to computer architecture. Some embodiments relate to a computer architecture for a dispatch platform that performs truck-load matching using artificial intelligence or other computer implemented techniques.

### BACKGROUND

Matching available trucks to loads is a problem in the logistics industry. Oftentimes, for large trucking enterprises, there is a high volume of loads and trucks, making it impossible for humans to manually determine optimal truck-load matches and routes in a timely manner. Without automation, logistics companies face significant operational challenges, including increased costs due to empty miles, idle driver times, and underutilization of fleet resources.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates a convolutional neural network, in accordance with some embodiments.

FIG. 5 is a block diagram of a computing machine, in accordance with some embodiments.

FIG. 6 is a block diagram of a computer architecture for truck-load matching, in accordance with some embodiments.

FIG. 7 is a data flow diagram of operation of a truckload planner, in accordance with some embodiments.

FIG. 8 is a data flow diagram of a first dispatch platform, in accordance with some embodiments.

FIG. 9 is a data flow diagram of a second dispatch platform, in accordance with some embodiments.

FIG. 10 is a data flow diagram of an example of dynamic planning, in accordance with some embodiments.

FIG. 11 is a block diagram of an example of a system for providing a dispatch platform, in accordance with some embodiments.

FIG. 12 illustrates an example of a load request dashboard, in accordance with some embodiments.

FIG. 13 illustrates an example of a truck route plan, in accordance with some embodiments.

FIG. 14 is a flowchart of an example technique for operating a dispatch platform, in accordance with some embodiments.

FIG. 15 is a flowchart of a first example technique for updating a dispatch platform, in accordance with some embodiments.

FIG. 16 is a flowchart of a second example technique for updating a dispatch platform, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, matching available trucks to loads is a problem in the logistics industry. Computer-implemented techniques for matching available trucks to loads and user interface techniques for displaying the generated truck-load matches in a human-readable manner may be desirable. Optimizing truck-load matches is a technical problem because there is a large search space-if there are m trucks, and n loads, there could be m*n different truck-load assignments. Ordering the loads for each truck (e.g., does the truck first handle load A or load B) further increases the number of options to consider. Efficiently searching through a large search space is a technical problem that leverages a technical solution.

Once a set of truck-load matches is generated, it may be desirable to add an additional load to the set, for example, in response to a new load order. Some schemes lack a streamlined way to efficiently integrate new load requests without disrupting existing plans. This inefficiency can lead to suboptimal utilization of trucks, increased operational costs, and missed revenue opportunities. Computer-implemented techniques for integrating an additional load into a set of truck-load matches may be desirable. Efficiently assigning the new load to a truck requires solving the technical problem of efficiently searching through all of the m trucks and determining whether the new load can be efficiently added to each truck.

Also, once a set of truck-load matches is generated, it may be desirable to add an additional truck to the set, for example, in response to cancellation of one or multiple loads assigned to the truck and disrupting its current schedule, termination or cancellation of a truck maintenance schedule, or termination or cancellation of a driver's personal time-off. Some schemes lack a streamlined way to efficiently assign loads to newly available trucks without disrupting existing plans. This inefficiency can lead to suboptimal utilization of trucks, increased operational costs, and missed revenue opportunities. Computer-implemented techniques for integrating an additional load into a set of truck-load matches may be desirable. Efficiently assigning loads to the newly added truck may require solving the technical problem of efficiently searching through all of the n loads and determining whether a load can be efficiently added to the newly added truck.

Implementations of the disclosed technology address the above problems by providing computer-implemented techniques that use specialized software to match available trucks to loads. Some implementations are directed to a computer system that uses an optimization engine to determine the optimal matches between trucks and loads, as well as the most efficient routes for each truck. The system collects data on available loads and trucks, including their locations, availability times, and constraints such as departure and delivery schedules. The optimization process involves a multi-step approach that includes data preparation, batch optimization, artificial intelligence (AI) optimization, and visualization. The AI optimization may leverage a graph neural network that considers various constraints, such as driver hour requirements, speed limits, and cost factors, to generate the most profitable and efficient plan for each truck, thereby minimizing empty miles and maximizing fleet utilization.

The disclosed technique offers significant advantages over manual methods, as the disclosed technique can rapidly evaluate a vast number of possible combinations, enabling logistics companies to optimize their operations effectively. The optimization engine may integrate data from multiple sources, such as load boards and truck availability updates, ensuring that the generated plans are up-to-date and reflective of real-world conditions.

Some implementations relate to a user interface for adding a new load to a pre-existing set of truck-load assignments. A user inputs new load data (e.g., at least one of origin location, destination location, departure time range, or delivery time range) into a graphical user interface accessible via a web browser or a specialized application at a client device. The new load data is transmitted to a server. The server evaluates the impact of the new load on current assignments, considering factors such as availability, cost, and time constraints, and then transmits multiple optimized plans with different time and price points to the client device for display thereat. The user of the client device may select one of the optimized plans or reject all of the optimized plans.

The disclosed user interface allows for quick decision-making by showing various load assignments for a proposed new truck, each tailored to fit the specific operational needs of the user (e.g., lowest price, fastest delivery, or lowest carbon emission). By providing a clear visualization of the various load assignments, the disclosed technique simplifies the decision-making process, reduces planning time, and ensures that new trucks are incorporated without causing disruptions to the overall fleet schedule.

Some implementations relate to a user interface for adding a new truck to a pre-existing set of truck-load assignments. A user inputs new truck data (e.g., at least one of projected time and location of availability, desired time and location of drivers' time-off, hours of service status, drivers' qualifications) into a graphical user interface accessible via a web browser or a specialized application at a client device. The new load data is transmitted to a server. The server evaluates the impact of the new truck on current assignments, considering factors such as availability, cost, and time constraints, and then transmits multiple optimized plans with different time and price points to the client device for display thereat. The user of the client device may select one of the optimized plans or reject all of the optimized plans.

The disclosed user interface allows for quick decision-making by showing various truck assignments for a proposed new load, each tailored to fit the specific operational needs of the user (e.g., lowest price, fastest delivery, or lowest carbon emission). By providing a clear visualization of the various truck assignments, the disclosed technique simplifies the decision-making process, reduces planning time, and ensures that new loads are incorporated without causing disruptions to the overall fleet schedule.

Human efforts, unaided by computers, at matching trucks to loads on a substantial scale would involve prohibitive delays, heightened error rates, and an inability to respond to dynamically shifting inputs such as unexpected truck availability or last-minute load requests. Therefore, addressing this challenge may require a technical, computer-implemented solution that optimizes the task in real-time, thereby enhancing operational efficiency and addressing logistical requirements far beyond the capabilities of a manual approach.

Some aspects of the disclosed technology include computer-implemented techniques that provide a clear improvement over manual logistics planning, offering efficiencies in both the scope and speed of matching trucks and loads. The disclosed system, according to some implementations, specifically tackles real-time computational optimization, integrating variables such as geographical constraints, load deadlines, and truck capacities that would be impractical for human logistics planners to manage manually. By addressing these variables programmatically, the disclosed system elevates a logistical challenge into a technical problem that merits a technical solution.

Moreover, integrating a new truck or load into an existing logistics plan without disrupting existing assignments is a significant technical obstacle, particularly given the constraints of fleet utilization, cost minimization, and real-time adjustments. In a manual approach, adding a new truck or load would likely necessitate revisiting and recalculating multiple assignments, leading to substantial delays and increased operational costs. The disclosed computer-implemented solution addresses this by recalculating assignments efficiently, relying on an optimization engine and potentially artificial intelligence to assess and adjust to each new input. Such adaptive recalibration constitutes a technical solution that not only reduces operational delays but also maximizes fleet utilization. Therefore, it aligns with the principles outlined in recent case law by providing a tangible technical improvement through its innovative approach to data processing and logistical adjustment.

Furthermore, the user interface implementation reinforces the practicality of the disclosed technique of some aspects by enabling operators to visualize and evaluate optimized plans with real-time data integration. Unlike a manual interface that would merely allow static data entry and require individual recalculations for each change, the disclosed interface provides a dynamic, multi-parameter decision-making tool that responds to real-world inputs. This capability ensures that logistics managers can adapt quickly to changing conditions, selecting optimal plans based on factors such as time and environmental impact. The combination of real-time data processing, optimization algorithms, and user-centered design provide a technical solution to a technical problem.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

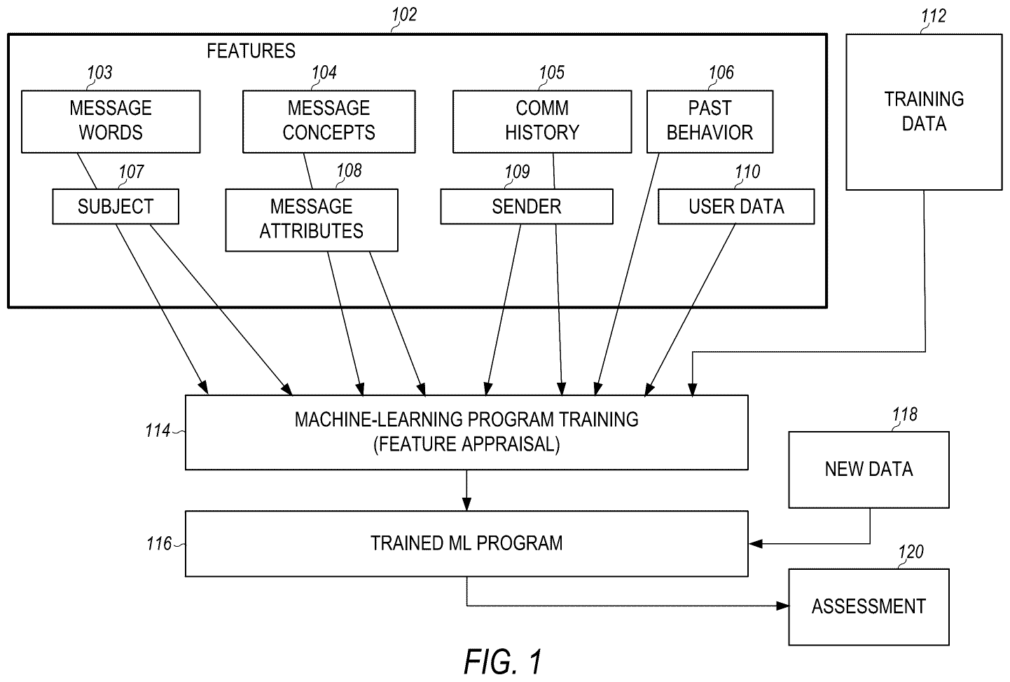

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks

(NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n′h epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

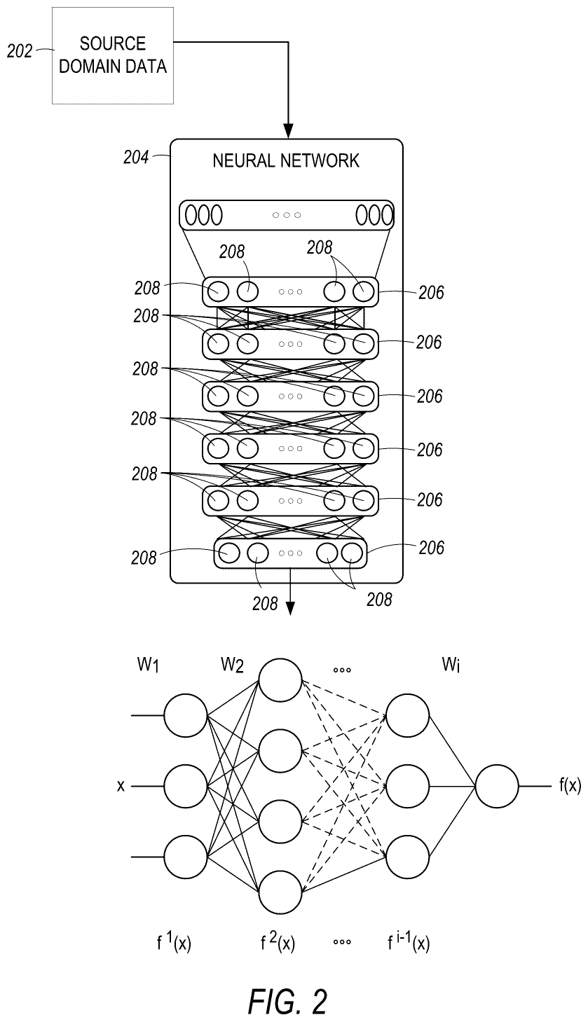

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

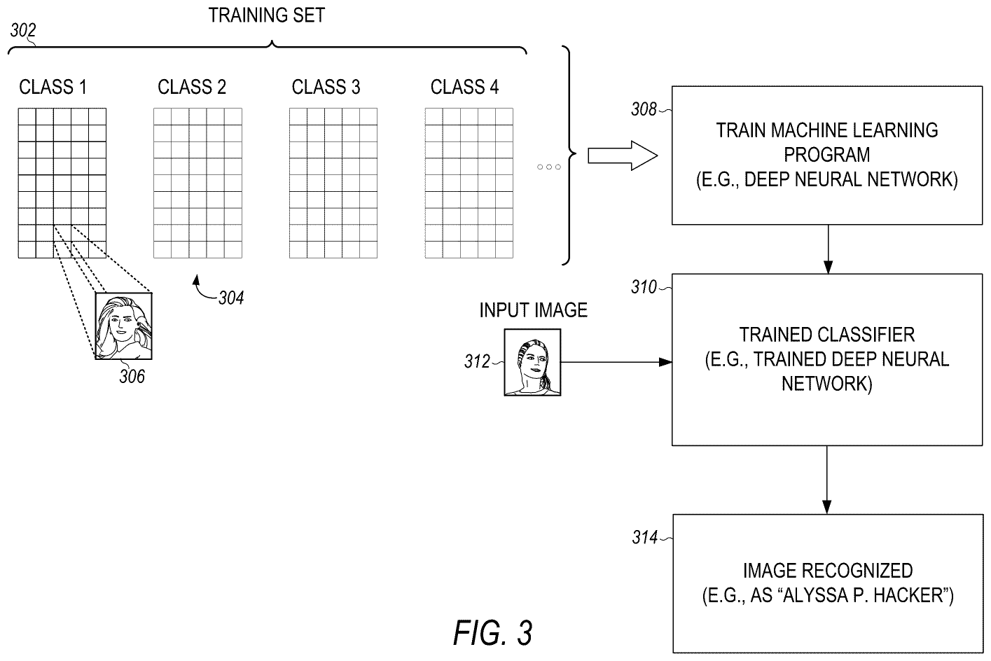

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.). At block 308 the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

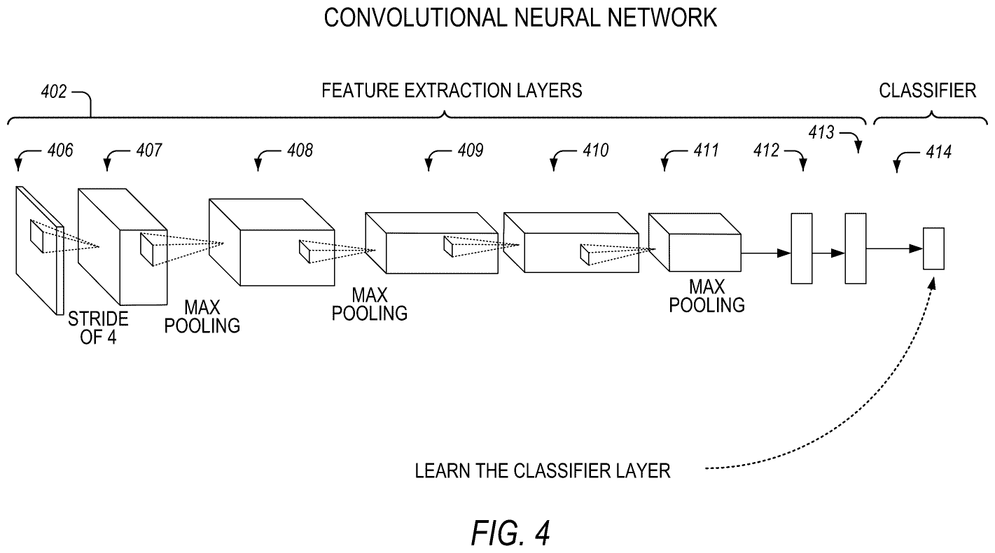

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

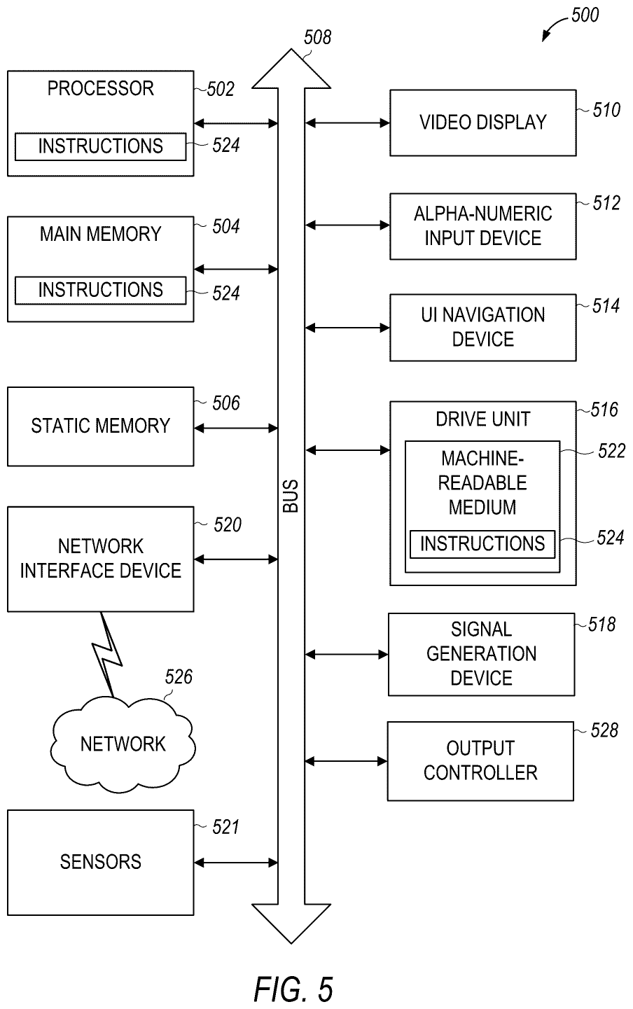

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Some implementations solve the optimal truck load planning problem. Some implementations relate to a platform for different logistics companies to optimally match their truckloads and available trucks for maximum profit, revenue, or mileage while reducing empty miles and drivers' idle times. In some cases, the optimal planning problem cannot be handled by humans due to the high number of truckloads and trucks, and thence the very high number of possible solutions to be evaluated.

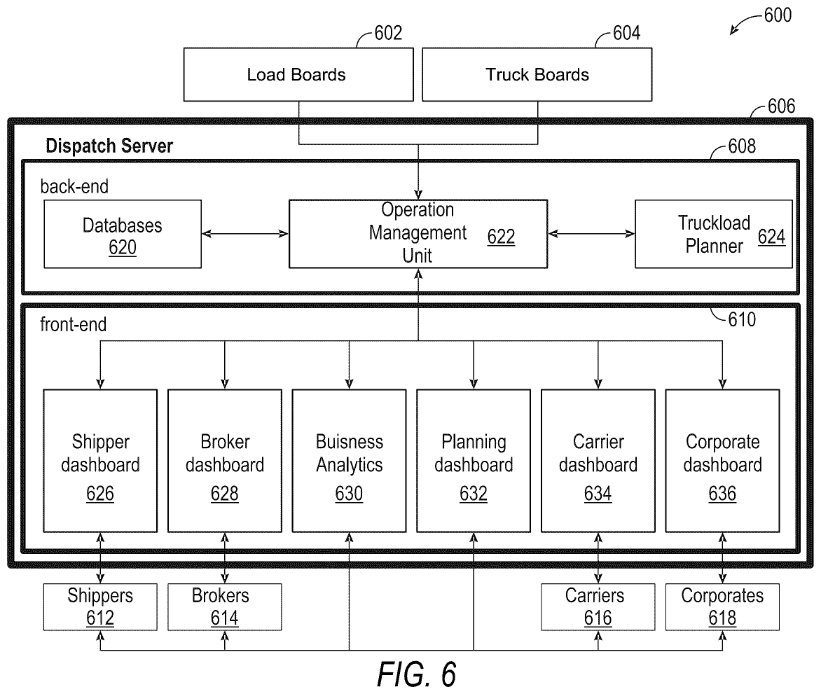

FIG. 6 is a block diagram of a computer architecture 600 for truck-load matching, in accordance with some embodiments. As shown, the computer architecture 600 includes load boards 602 and truck boards 604, which are provided to a dispatch server 606. The dispatch server 606 includes a back-end 608 and a front-end 610. The front-end 610 outputs data to computing devices of a shipper 612, a broker 614, a carrier 616, and/or a corporate 618.

As shown, the back-end 608 includes databases 620, an operations management unit (OMU) 622, and a truckload planner 624. The OMU 622 receives the data from the load boards 602 and the truck boards 604 and transforms the data into a standardized format. The OMU 622 accesses the databases 620 to identify road closures, road constructions, speed limit changes, or the like. The OMU 622 communicates with the truckload planner 624 to generate a plan matching trucks of the truck boards 604 to loads of the load boards 602. The OMU 622 obtains the plan from the truckload planner 624. The OMU 622 transmits the plan, in various formats, to the front-end 610.

As shown, the front-end 610 includes shipper dashboard 626, broker dashboard 628, business analytics 630, a planning dashboard 632, carrier dashboard 634, and corporate dashboard 636. The OMU 622 transforms the plan into a shipper format and transmits it to the shippers' dashboard & forms 626. The OMU 622 transforms the plan into a broker format and transmits it to the broker dashboard 628. The OMU 622 transforms the plan into a business format and transmits it to the business analytics 630. The OMU 622 transforms the plan into a planning format and transmits it to the planning dashboard 632. The OMU 622 transforms the plan into a carrier format and transmits it to the carrier dashboard 634. The OMU 622 transforms the plan into a corporate format and transmits it to the corporate dashboard 636.

The front-end 610 is accessible by external computing devices. The shipper dashboard 626 is accessible to a computing device of a shipper 612. The broker dashboard 628 is accessible to a computing device of a broker 614. The carrier dashboard 634 is accessible to a computing device of a carrier 616. The corporate dashboard 636 is accessible to a computing device of a corporate 618.

The front-end 610 may include a web portal or a mobile application to enable clients to communicate, via computing devices, their truckload and truck data with the back-end 608 mainly via following dashboards, forms, and analytics pages. The front-end includes dashboards 626, 628, 632, 634, and/or 636 for clients to submit data for processing by the OMU 622 and receive output from the OMU 622.

The dashboards 626, 628, 632, 634, and/or 636 may be configured to receive forms. In addition to structured data forms to collect data from clients, the dashboards 626, 628, 632, 634, and/or 636 may include one or multiple chat boxes to collect data and requests from clients in their own words. These chat boxes could be filled by typing or converting clients' voices to text at computing devices associated with the clients. Also, client data and requests could be collected via other platforms including text, social media platforms, and emails. After any clients' truckload planning problem is solved, computing devices of the clients can access, review, and/or modify their plans through the planning dashboard 632. The planning dashboard 632 also gives clients access to communicate their planning preferences with the OMU 622.

The business analytics 630 provides clients with the analytical studies on market data and their own long-term data including but not limited to network capacity studies, fleet expansion plans, and fleet value analysis. The business analytics 630 may be output to computing devices of the clients, for example, via a webpage or a mobile application.

The back-end 608 may include a cloud server to manage data exchange and optimal planning processes. The OMU 622 manages exchange between the databases 620 and other components such as the truckload planner 624, the front-end 610, and any external resources. The OMU 622 forms a queue for the truckload planning problems requested by clients and manages the queue for the truckload planner 624. The OMU 622 collects data from external resources to be used in the planning process and/or analytical studies.

The truckload planner 624 receives the truckload planning problem from the queue formed by the OMU 622. The truckload planner 624 solves the truckload planning problem, for example, using optimization techniques, and submits the result to the OMU 622 to be stored in the databases 620 and/or shared with the front-end 610.

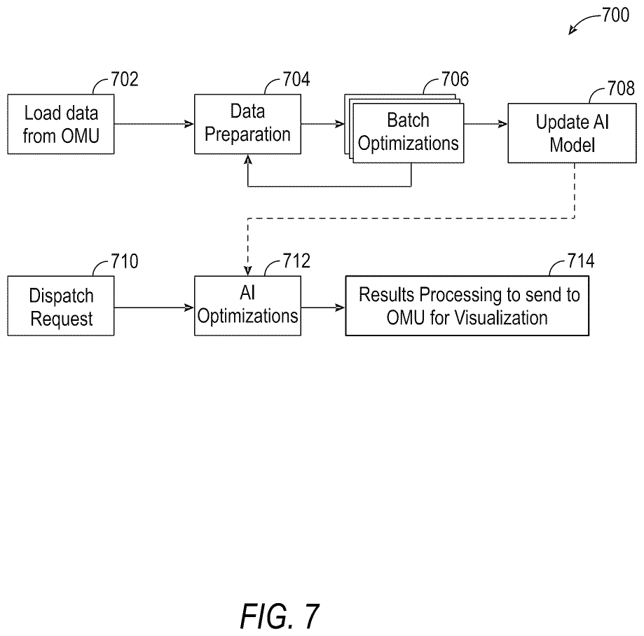

FIG. 7 is a data flow diagram of operation of a truckload planner 700, in accordance with some embodiments. The truckload planner 700 may correspond to the truckload planner 624 of FIG. 6.

At block 702, the truckload planner 700 loads data from the OMU 622. At block 704, the truckload planner 700 performs data preparation. At 706, the truckload planner 700 performs batch optimizations, passing the output to block 704 for further data preparation and to block 708. At block 708, the truckload planner 700 updates the AI model. At block 710, the truckload planner 700 receives a dispatch request. At block 712, the truckload planner 700 performs AI optimization to assign the dispatch request of block 710 using the updated AI model of block 708. At block 714, the results of the AI optimization of block 712 are sent, by the truckload planner 700, to the OMU 622 for visualization.

In the data preparation of block 704, as soon as new data is received from the load boards 602, through the OMU 622, the data is prepared for the batch optimization of block 706. The data preparation includes collecting data from the load boards 602. The data preparation includes transforming the data into desired formats. The data preparation includes cleaning the data by fixing or removing data points that are missing or data points that include bad data. The data preparation includes sorting loads based on pay rate for each state-to-state lanes and each pickup date, and keeping the highest-paying loads (e.g., loads paying more than a threshold amount, a threshold amount per mile, or a threshold amount per hour of estimated driving time).

In the batch optimization of block 706, after the data is prepared, batch optimizations are performed. Batch optimization includes creating independent and virtual dispatching requests from the prepared data and run individual optimizations in parallel. Batch optimization includes creating a limited load list by keeping the highest paying loads for each pickup state and pickup date. Batch optimization includes using the limited load list to generate a virtual truck list. Pickup location and time of each load may be defined in a schedule of one of the virtual trucks. Batch optimization may include, for each truck in the virtual truck list, creating a time-off request for the truck in the pickup city a threshold time period (e.g., five days) after the pickup time, and optimizing the truckload planning to maximize net profit for the truck while implementing a set of constraints. The set of constraints may include at least one of the following: (i) no more than one truck load is assigned to the truck at any time, (ii) assigned pick-up times between earliest and latest pick-up times as set by shippers, (iii) assigned drop-off times between earliest and latest drop-off times as set by shippers, (iv) assigned pickup and drop off times must allow for enough time to drive between pickup and drop off locations, (v) the time difference between drop off time of any assigned load and the pickup time of the next consecutive load must allow for enough time to drive (deadhead) from a load destination to a load origin, (vi) rules on truck driver hours of service (HOS), (vii) total revenue is the summation of pay rates of assigned loads, (viii) total cost is the summation of mileage costs of assigned loads and deadheads between loads (total cost may account for the driver's salary and fuel costs), or (ix) total profit is total revenue minus total cost.

The rules on truck driver HOS may be set by a statute, a government agency (e.g., Department of Transportation) or by best practices. The rules on truck driver HOS may include at least one of the following: (1) no more than a threshold time (e.g., 11 hours) of driving after a threshold off duty time (e.g., 10 consecutive off duty hours), (2) no more than a threshold time (e.g., 14 hours) of on duty (including driving) time after a threshold off duty time (e.g., 10 consecutive off duty hours), (3) a 30-min (or other time period) break after any consecutive hours of driving, or (4) no more than a threshold time (e.g., 60 hours or 70 hours) of driving during a threshold number (e.g., 7 or 8) of days of on-duty hours after a threshold off-duty time (e.g., 36 hours consecutive off-duty hours).

In batch optimization, each optimization may result in an optimal sequence (route) of truckloads. For each optimal route, the truckload planner 700 generates sub-optimal chains of truck loads by keeping consecutive assigned loads only. In batch optimization, the truckload planner 700 updates the total revenue, the total cost and the total mileage of chains. In batch optimization, the truckload planner 700 collects all original routes and sub-optimal chains in a database. We call this collection of results an AI model. In batch optimization, the truckload planner 700 goes back to data preparation operation (of block 704) for batch optimization on updated data.

In the AI optimization of block 712, for each dispatch request for multiple trucks, the truckload planner 700 determines and ranks the best routes based on the projected times and locations of availability (PTLA) of the trucks. AI optimization includes receiving dispatch requests from the OMU 66 including the trucks' PTLA. AI optimization includes crossing the truck list with the updated chain list from the latest Batch Optimization process. AI optimization includes calculating initial deadhead cost, mileage, and required time of traveling from PTLA location to the first loads of chains. AI optimization includes calculating final deadhead cost, mileage, and required time of deadheading from the drop off location of last orders in the chains to the time-off locations are calculated. AI optimization includes filtering out the combinations where initial deadhead time exceeds the time difference between PTLA and start of first load in the chain. AI optimization includes filtering out the combinations where the sum of initial and final deadhead costs exceeds the net profit of the chain. AI optimization includes sorting the combinations based on total net income, total revenue and total miles. AI optimization includes, for each truck, extracting first chains of loads or with highest revenue, net income, or driving miles. AI optimization includes consolidating the extracted chains in the result file (or another data structure). AI optimization includes send the results to the OMU 622 for visualization on a portal or a website accessible via the front-end 610.

In the visualization of block 714, once the AI optimization results (e.g., the plans including the truck-load matches) are ready, they are sent to the OMU 622 for visualization on the portal or the website. The OMU 622 receives these data from the truckload planner 624 (e.g., the truckload planner 700). The OMU 622 then performs the following operations before sending the plans to the front-end 610 for visualization.

The OMU 622 formats the plan to cause display of sorted results in different tabs. Each plan may have a section. The OMU 622 computes metrics including, for example and without limitation, net income, total miles deadhead percentages, or total revenue in each section. The OMU 622 generates plan details, including route, timing, and map, which may be accessible via a link from a graphical user interface displaying the section.

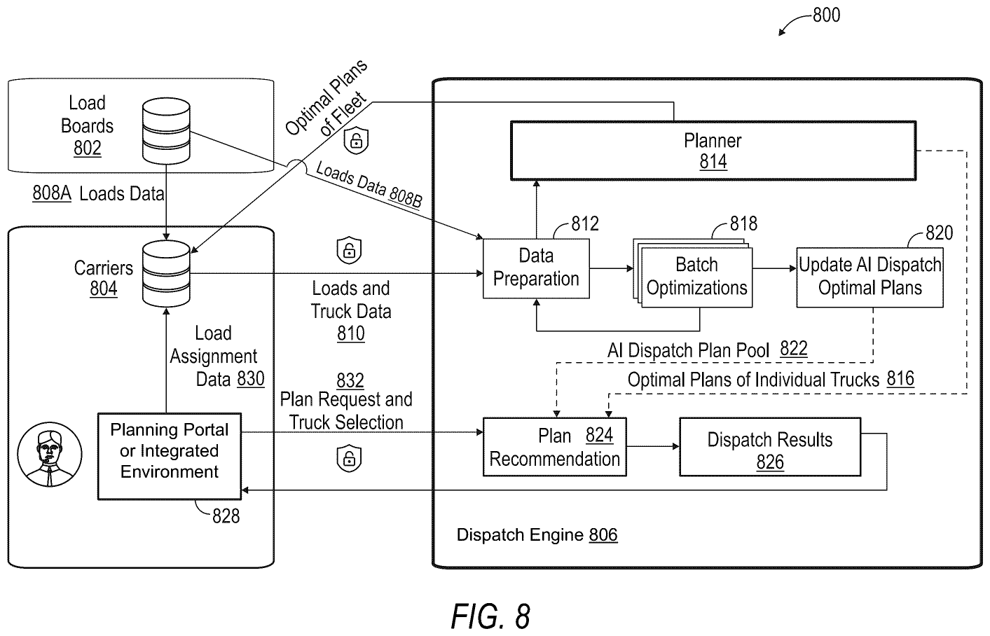

FIG. 8 is a data flow diagram of a first dispatch platform 800, in accordance with some embodiments. As shown, the dispatch platform 800 includes load boards 802, carriers 804, and a dispatch engine 806. The dispatch engine 806 may execute on one or more computing machines, such as one or more servers. The load boards 802 communicate loads data 808A (e.g., representing a set of available loads, some of which are to be taken and others of which are optional) to the carriers 804. The load boards 802 communicate loads data 808B (which may be similar to or somewhat distinct from the loads data 808A) to the dispatch engine 806. The carriers 804 communicate loads and trucks data 810 of the carriers to the dispatch engine 806. The loads and trucks data 810 may include the loads data 808A. The carriers 804 may represent any source of truck data including carriers, independent dispatchers, any aggregator of carriers' trucks, or any entity representing carriers or truck aggregators. The load boards 802 may represent any source of load data such as shippers, brokers or any aggregator of shippers' loads, load boards or any aggregator of shippers and brokers' loads, or any aggregator of loads from shippers, brokers, or load boards.

The dispatch engine 806 performs data preparation 812 on the loads and trucks data 810 from the carriers and the loads data 808B from the load boards 802. The output of the data preparation 812 is provided to a planner 814. The planner 814 perform an optimization for the fleet of trucks and outputs optimal plans of individual trucks 816.

The output of the data preparation 812 is provided to the batch optimizations 818. The batch optimizations 818 generate updated AI dispatch optimal plans 820. The updated AI dispatch optimal plans 820 outputs an AI dispatch plan pool 822. The dispatch engine 806 then generates a plan recommendation 824 based on the AI dispatch plan pool 822 and the optimal plans of individual trucks 816. The plan recommendation 824 is provided as dispatch results 826, and the dispatch results 826 are transmitted to the carriers 804. At the carriers 804, the dispatch results 826 are output vis a planning portal or integrated environment 828. The carriers 804 output and store the load assignment data 830 from the planning portal or integrated environment 828. The planning portal or integrated environment 828 outputs plan request and truck selection information 832 to the plan recommendation 824 of the dispatch engine 806 for storage by the dispatch engine 806 and/or training (e.g., using online learning) of the dispatch engine 806.

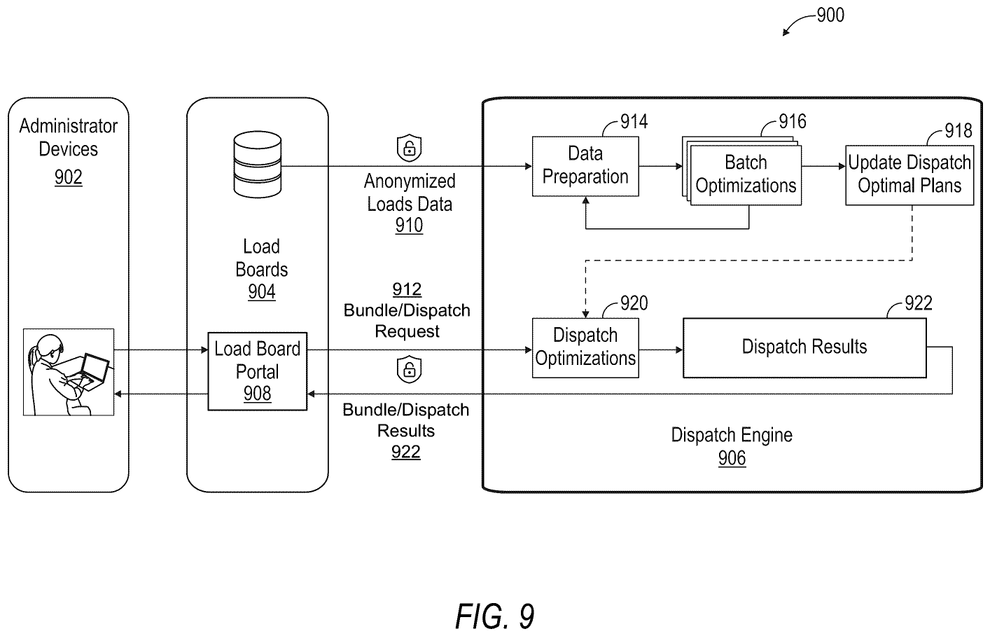

FIG. 9 is a data flow diagram of a second dispatch platform 900, in accordance with some embodiments. As shown, the dispatch platform 900 includes administrator devices 902, load boards 904, and a dispatch engine 906. The administrator devices 902 may be associated with at least one of a broker, a carrier, or an independent dispatcher. The dispatch engine 906 (similarly to the dispatch engine 806) may execute on one or more computing machines, such as one or more servers. The load boards 904 may include, among other things, at least one of a shipper, any aggregator of shippers' loads such as brokers, any aggregator of shippers and brokers' loads such as load boards, or any aggregator of loads from any source. The administrator devices 902 may represent any entities or individuals interacting with 908 to initiate a bundle/dispatch request 912 and receive the corresponding bundle/dispatch result 922. Some examples are, but are not limited to, load boards, load boards' clients, carriers, brokers, shippers, and independent dispatchers.

As shown, the load boards 904 include a load board portal 908. The load board portal 908, among other things, enables communication between the administrator devices 902 and the load boards 904, allowing the administrator devices 902 to access the data of the load boards 904. The load boards transmit anonymized loads data 910 to the dispatch engine 906. The load board portal 908 of the load boards 904 transmits a bundle request 912 to the dispatch engine 906. The dispatch engine 906 performs data preparation 914 and batch optimizations 916 on the anonymized loads data 910. The dispatch engine 906 updates the dispatch optimal plans 918 based on the output of the batch optimizations 916. A dispatch optimization block 920 of the dispatch engine 906 receives the updates of the dispatch optimal plans 918 and the bundle request 916 and outputs the bundle/dispatch results 922. The bundle/dispatch results 922 are transmitted to the load board portal 908 of the load boards 904. The load board portal 908 is accessible to the administrator devices 902.

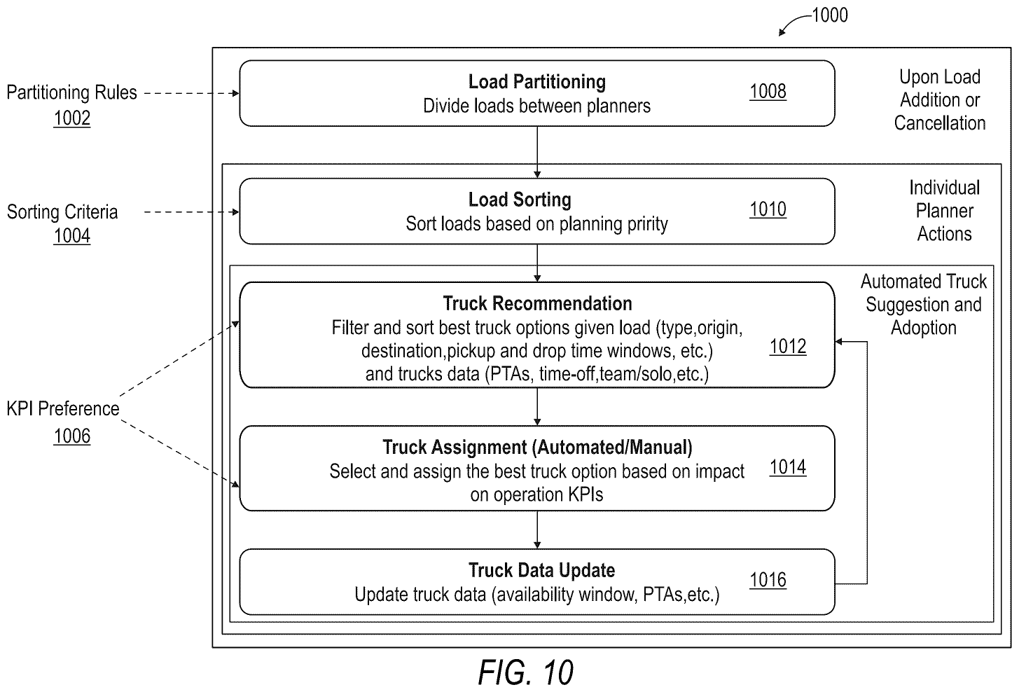

FIG. 10 is a data flow diagram of an example of dynamic planning 1000, in accordance with some embodiments. The dynamic planning 1000 may implement automation. As shown, the dynamic planning 1000 includes partitioning rules 1002, sorting criteria 1004, and key performance indicator (KPI) preference 1006.

The partitioning rules 1002 correspond to load partitioning 1008, which divides loads between planners upon load addition or cancellation.

The sorting criteria 1004 correspond to load sorting 1010, which sorts loads based on planning priority and is performed by individual planners.

Truck recommendation 1012 is done based on the KPI preference 1006. Truck recommendation 1012 include filtering and sorting the best truck options for given load data (e.g., type origin, destination, pickup and drop time windows, etc.) and truck data (projected time of availability (PTA), time off, team/solo, etc.).

Truck assignment 1014 may be automated or manual and is based on the KPI preference 1006. Truck assignment 1014 involves selecting and assigning the best truck options based on the impact on operation KPIs.

Truck data update 1016 includes updating the truck data (e.g., availability window, PTA, etc.) based on the new truck-load assignment. The truck recommendation 1012, the truck assignment 1014, and the truck data update 1016 correspond to automated truck suggestion and adoption.

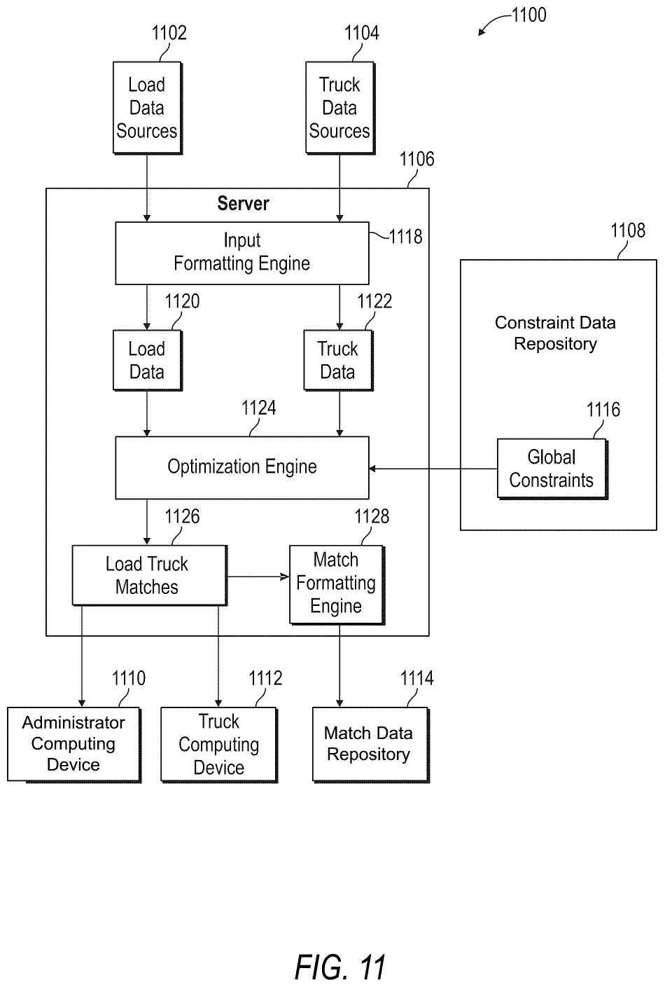

FIG. 11 is a block diagram of an example of a system 1100 for providing a dispatch platform, in accordance with some embodiments. As shown, the system 1100 includes load data sources 1102, truck data sources 1104, a server 1106, a constraint data repository 1108, an administrator computing device 1110, a truck computing device 1112, and a match data repository 1114.

The load data sources 1102 may correspond to at least one of the load boards 602, the load boards 802, or the load boards 904 and may store data about available loads. The truck data sources may correspond to the truck boards 604 and may store data about available trucks. The server 1106 may include one or more computing machines, such as the computing machine 500. As shown, the constraint data repository 1108 stores global constraints 1116, which constrain the operation of trucks or loads due to physical limitations (e.g., truck volume) or operational limitations (e.g., legal or best practice limitations or regulations, such as limitation regarding driver time off, speed limits).

The administrator computing device 1110 may correspond to at least one of the carriers 804 or the administrator devices 902. The truck computing device 1112 may correspond to a mobile device associated with a truck or an on-board computing device of a truck. The match data repository 1114 is a data repository storing truck-load matches. Each of the constraint data repository 1108 or the match data repository 1114 may be a database or another data storage structure.

As shown, the server 1106 ingests data from the load data sources 1102 and the truck data sources 1104. An input formatting engine 1118 of the server 1118 receives the ingested data and generates load data 1120 in a standardized load format and truck data 1122 in a standardized truck format.

An optimization engine 1124 of the server 1106 obtains the load data 1120, the truck data 1122, and the global constraints 1116 from the constraint data repository 1108. The optimization engine 1124 performs an optimization to generate load-truck matches 1126 matching at least one load to at least one truck based on the load data 1120, the truck data 1122, and the global constraints 1116.

According to some implementations, the optimization engine 1124 is a multilayered graph neural network (GNN). To generate the load-truck matches 1126, the optimization engine 1124 represents the load data 1120 and truck data 1122 as a graph data structure with nodes corresponding to individual loads and trucks, and edges representing potential matches between loads and trucks. The optimization engine 1124 evaluates each edge based on learned dependencies among features in the load data 1120, the truck data 1122, and the global constraints 1116. The optimization engine 1124 iteratively adjusts edge weights to optimize at least one numeric value (e.g., at least one of (or a mathematical function of at least one of) a total monetary cost, a total distance travelled, a total hours of driving, or a total carbon emissions) by selecting a first subset of the edges and rejecting a second subset of the edges. The first subset and the second subset are mutually exclusive and collectively exhaustive.

After the load-truck matches 1126 are generated, the load-truck matches 1126 are provided to a match formatting engine 1128. The match formatting engine 1128 transforms the load-truck matches into a match format for storage in the match data repository 1114. Some off the load-truck matches 1126 are transmitted to the administrator computing device 1110 associated with the loads and the trucks. Furthermore, some of the load-truck matches are transmitted to the truck computing device 1112 of a truck that will be transporting the loads. As a result, truck drivers and entities managing the truck drivers are notified of the loads assigned to their trucks.

The GNN, which may be implemented by the optimization engine 1124, is a specialized type of neural network designed to operate on graph-structured data, where the data is represented in terms of nodes (entities) and edges (relationships between entities). Unlike traditional neural networks that handle data in Euclidean spaces (like images or sequences), GNNs are adept at capturing the complex dependencies and interactions inherent in graph data. They achieve this by iteratively passing and aggregating information across the nodes and edges of the graph, enabling the network to learn representations that consider both the features of individual nodes and the topology of the graph.

In the context of generating the load-truck matches 1126, utilizing a GNN is particularly advantageous due to the natural graph representation of the problem. Here, individual loads and trucks are represented as nodes, and the potential matches between them are depicted as edges connecting the corresponding nodes. The GNN can evaluate each edge by considering learned dependencies among the features of the loads, trucks, and the global constraints 1116, such as delivery deadlines, load capacities, and route optimizations, stored in the constraint data repository 1108.

By employing the multilayered GNN within the optimization engine 1124, the server 1106 can iteratively adjust the weights of the edges to optimize specific numerical objectives, such as minimizing transportation costs or maximizing delivery efficiency. This process involves selecting a subset of edges (representing optimal load-truck matches) while rejecting others, ensuring that the chosen matches collectively satisfy all constraints and optimization criteria. The GNN's ability to model and process the interconnected relationships between loads and trucks makes it a useful tool for solving complex logistical optimization problems in this context.

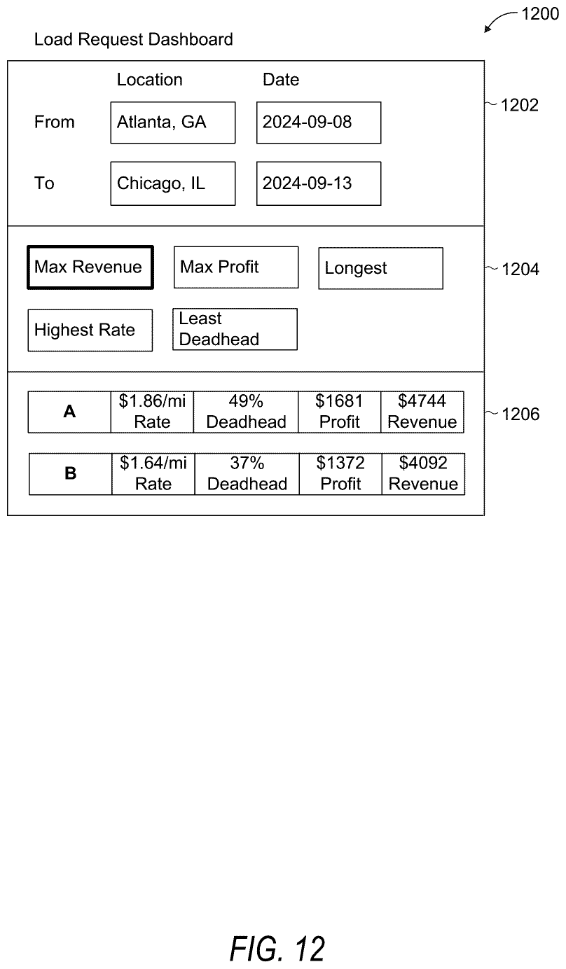

FIG. 12 illustrates an example of a load request dashboard 1200, in accordance with some embodiments. The load request dashboard 1200 may be presented at an administrator computing device (e.g., at least one of the carriers 804, the administrator devices 902, or the administrator computing device 1110). As shown, the load request dashboard 1200 allows a user, at region 1202, to specify an origin (“from”) location and date of a load and a destination (“to”) location and date of the load. The user may select, at region 1204, a scheme for ordering the search results from among: max (maximum) revenue, max profit, longest, highest rate, and least deadhead. As shown, the user has selected “max revenue.” Based on the user input, search results are presented at region 1206. The user may select one of the search results to obtain more information and/or to confirm the load-truck match.

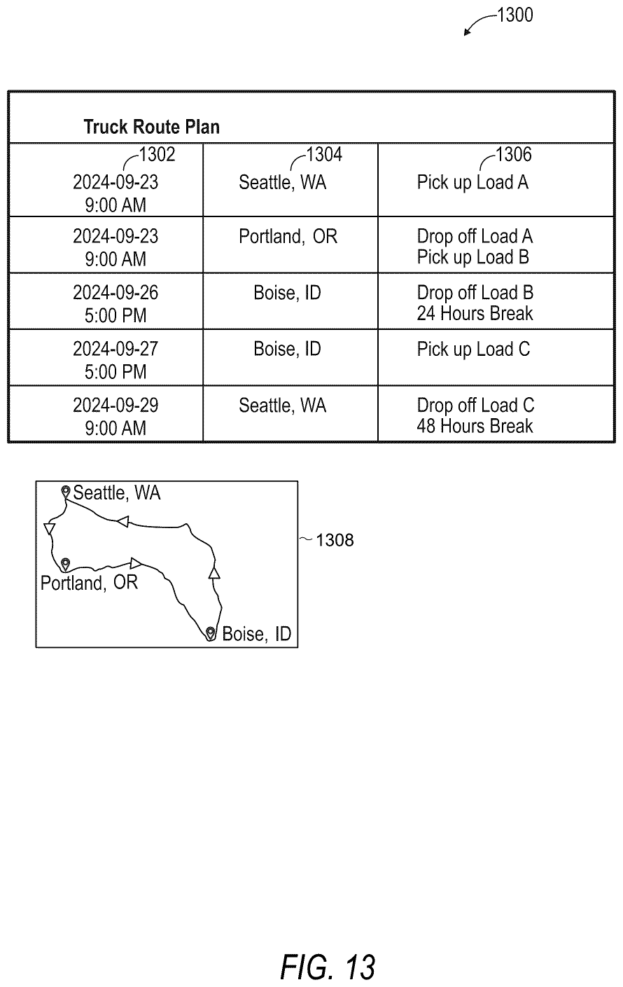

FIG. 13 illustrates an example of a truck route plan 1300, in accordance with some embodiments. The truck route plan 1300 may be transmitted from the server 1106 to the truck computing device 1112 and displayed at the truck computing device 1112. As shown, the truck route plan 1300 includes a time column 1302, a location column 1304, and an activity column 1306. Each row corresponds to a time when the truck is to be at the location and the activities the truck is to engage in at the location (e.g., pick up load, drop off load, or take a break). The truck route plan 1300 also include a map 1308 of a route along which the truck may travel. By viewing the truck route plan 1300, a user of the truck computing device 1112 (e.g., a driver of the truck) may learn the route plan, the schedule of the truck, and destinations to be visited by the truck.

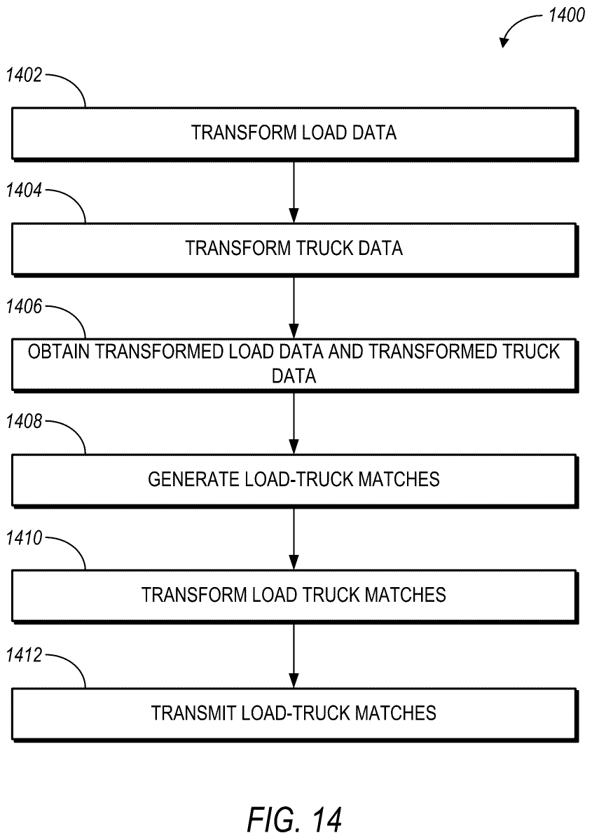

FIG. 14 is a flowchart of an example technique 1400 for operating a dispatch platform, in accordance with some embodiments. The technique 1400 can be executed using computing devices, such as the systems, hardware, and software described with respect to FIGS. 1-13. The technique 1400 can be performed, for example, by executing machine-readable instructions, routines, or programs. The operations of the technique 1400, or another technique, process, or algorithm described in connection with the implementations disclosed herein, can be implemented directly in hardware, firmware, software executed by hardware, circuitry, or a combination thereof. The technique 1400 can be implemented by a server (e.g., the server 1106) that communicates with various load data sources and truck data sources, as described herein.

At 1402, an input formatting engine (e.g., the input formatting engine 1118) of the server transforms load data from a plurality of load data sources into a standardized load format. This transformation process involves normalizing and structuring diverse load data so that it can be uniformly processed by an optimization engine (e.g., the optimization engine 1124). The load data may include various attributes such as load locations, departure times, delivery times, load types, weights, and other relevant information.

At 1404, the input formatting engine transforms truck data from a plurality of truck data sources into a standardized truck format. Similar to the load data transformation, this operation ensures that truck data from different sources is converted into a consistent format. The truck data may include attributes such as truck locations, capacities, availability schedules, compliance constraints, and other pertinent details.

At 1406, the optimization engine of the server obtains the load data in the standardized load format and the truck data in the standardized truck format. By working with standardized data formats, the optimization engine can efficiently process the information to generate optimal matches.

At 1408, the optimization engine generates load-truck matches by matching at least one load to at least one truck based on the load data, the truck data, and a set of global constraints (e.g., the global constraints 1116) stored in a constraint data repository (e.g., the constraint data repository 1108). According to some implementations, the optimization engine comprises a multilayered graph neural network, which allows it to model complex relationships and dependencies between loads and trucks.

According to some implementations, generating the load-truck matches includes representing the load data and truck data as a graph data structure, with nodes corresponding to individual loads and trucks, and edges representing potential matches between loads and trucks. The optimization engine evaluates each edge based on learned dependencies among features in the load data, the truck data, and the global constraints. These features may include attributes such as load locations, truck locations, departure and delivery time ranges, revenue potential, and compliance constraints (e.g., from the set of global constraints).

The optimization engine iteratively adjusts edge weights to optimize at least one numeric value by selecting a first subset of the edges and rejecting a second subset of the edges, where the first subset and the second subset are mutually exclusive and collectively exhaustive. The numeric value being optimized can be based on factors such as revenue, cost, profit, carbon emissions, or mileage. This iterative process allows the optimization engine to find the most efficient and profitable matches between loads and trucks.

At 1410, a match formatting engine (e.g., the match formatting engine 1128) of the server transforms the load-truck matches into a match format suitable for storage in a match data repository (e.g., the match data repository 1114). This transformation prepares the generated matches for storage, retrieval, and further processing by other system components or for presentation to users.

At 1412, the server transmits the load-truck matches in the match format to the match data repository. The matches can then be accessed by client devices or other systems for dispatching trucks, notifying drivers, or other operational actions.

In some implementations, the server causes display at a client device of a graphical user interface representing the load-truck matches. The graphical user interface may include a dashboard layout that includes multiple interactive panels displaying key performance indicators related to the load-truck matches. The key performance indicators may include profit, revenue per mile, fuel cost, mileage traveled, or deadhead percentage.

The graphical user interface may include a visual map interface that graphically represents a route associated with at least one load-truck match, including origin location, destination location, route path, and estimated travel time, with visually indicated (e.g., color-coded or highlighted) lines indicating the status of route segments.

Additionally, the graphical user interface may include a filter and search toolbar enabling a user to sort and filter load-truck matches based on criteria such as profit margin, distance, driver availability, compliance status, or load type.

In some implementations, the graphical user interface includes a load-truck matching matrix indicating the load-truck matches in cells of the matrix. Upon receiving an indication of a selection of a cell, the server displays additional data related to the load-truck match of that cell.

The graphical user interface may also include a dashboard comprising at least one graph indicating metrics such as truck utilization rate, mileage rate, profit rate, revenue rate, or match rate of loads to trucks.

In some implementations, the server causes display at a client device of a truck view interface indicating loads assigned to at least one truck, and transmits to a computing device associated with the at least one truck an indication of the loads assigned and a proposed route. This enables drivers to receive real-time updates on their assignments and optimized routes.

The server may provide a modification interface for a user to manually assign a first load to a first truck or to manually remove an assignment of a second load to a second truck. This allows for human oversight and adjustments to the automated matching process.

In some implementations, the load data comprises a first set of mandatory loads and a second set of optional loads, wherein the load-truck matches include the first set of mandatory loads and a subset of the second set of optional loads. This ensures that essential deliveries are prioritized while optimizing additional capacity.

The multilayered graph neural network used by the optimization engine may include at least one input layer, one or more hidden layers, and an output layer. The input layer receives node features representing attributes of loads and trucks. The hidden layers perform graph convolutional operations that aggregate information from neighboring nodes and edges to capture relationships between loads and trucks. The output layer generates a matching score for each load-truck pairing based on the aggregated node and edge features, and the load-truck matches are generated based on these matching scores.

In some implementations, the multilayered graph neural network iteratively adjusts the edge weights by using a message-passing sub-engine to transmit information between connected nodes, allowing each node to update its state based on the states of neighboring nodes and attributes of connecting edges, and by using a gradient-based optimization sub-engine to adjust weights of the edges based on optimizing the numeric value. This approach enables the network to learn complex patterns and dependencies in the data to improve matching accuracy.

The technique 1400 provides an efficient and optimized approach to matching loads with trucks in a logistics network, leveraging advanced machine learning techniques and standardized data formats to improve operational efficiency and profitability. By transforming disparate data sources into standardized formats and employing a multilayered graph neural network, the server can handle complex constraints and objectives, resulting in better utilization of resources and increased revenues.

In an example use case, a server of a logistics company is managing freight operations involving multiple shippers and carriers. The company receives load data from various shippers, where each dataset includes details like origin and destination locations, pickup and delivery time windows, load types, weights, and special handling requirements. Simultaneously, the server collects truck data from different carriers, containing information about truck capacities, current locations, availability schedules, driver qualifications, and compliance constraints.

The server's input formatting engine processes the heterogeneous load data from the shippers. It transforms this data into a standardized load format, normalizing the diverse attributes so that all loads are represented uniformly. This standardization is crucial for the optimization engine to effectively analyze and compare the loads.

The input formatting engine similarly transforms the truck data from the carriers into a standardized truck format. This involves reconciling differences in data representations, such as units of measurement and terminology, to create a consistent dataset of truck information.

With both the load and truck data standardized, the optimization engine obtains these datasets to begin the matching process. The engine is designed to handle complex optimization problems and uses a multilayered graph neural network to model the relationships between loads and trucks.

The optimization engine represents the loads and trucks as nodes within a graph data structure. Edges between these nodes represent potential matches, indicating that a particular truck could potentially carry a specific load. The engine evaluates each edge by analyzing learned dependencies among various features from the load and truck data, such as locations, time constraints, capacity, and compliance with regulations. It also considers global constraints stored in a constraint data repository, like maximum allowable driving hours and weight limits.

The optimization engine iteratively adjusts the weights of these edges to optimize a numeric value, such as maximizing total revenue, minimizing operational costs, or reducing carbon emissions. Through this process, it selects a subset of edges (load-truck matches) that collectively provide the best optimization according to the chosen criteria, while rejecting other less optimal matches.

A match formatting engine of the server transforms the selected load-truck matches into a specific match format suitable for storage and retrieval. This includes organizing the matches in a way that can be easily accessed and understood by other system components or users.

Finally, the server transmits the formatted load-truck matches to a match data repository. This repository serves as a centralized database where the matches are stored for operational use. Dispatchers and planners can access this repository through a graphical user interface that displays the matches along with key performance indicators like profit margins, revenue per mile, fuel costs, and deadhead percentages.

The output generated allows the logistics company to efficiently assign loads to trucks, optimize routes, and ensure compliance with various constraints. Drivers receive their assignments and proposed routes through connected devices, enabling real-time updates and communication. If necessary, dispatchers can manually adjust assignments using the modification interface provided by the system, allowing for flexibility in handling unexpected changes or priorities.

This use case demonstrates how the system integrates disparate data sources, leverages advanced machine learning techniques, and provides actionable outputs to optimize logistics operations effectively.

Some implementations relate to a system that efficiently pairs freight loads with available trucks by collecting and standardizing data from multiple sources. The system uses advanced artificial intelligence to analyze this information, considering various constraints and relationships, to find the best matches between loads and trucks. By representing loads and trucks as interconnected nodes in a network and optimizing these connections, the system enhances logistics efficiency, leading to better resource utilization and potential cost savings.

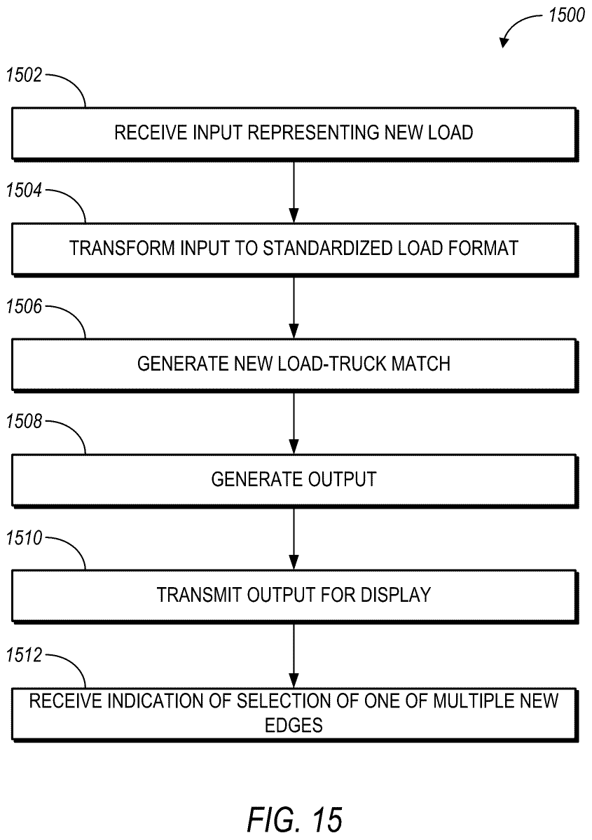

FIG. 15 is a flowchart of an example technique 1500 for updating a dispatch platform, in accordance with some embodiments. Updating the dispatch platform may include adding a new load to an existing set of load-truck matches. The technique 1500 can be executed using computing devices, such as the systems, hardware, and software described with respect to FIGS. 1-13. The technique 1500 can be performed by executing machine-readable instructions, routines, or programs. The steps or operations of the technique 1500, or another technique, process, or algorithm described in connection with the implementations disclosed herein, can be implemented directly in hardware, firmware, software executed by hardware, circuitry, or a combination thereof. The technique 1500 can be implemented by a server (e.g., the server 1106) that communicates with client devices and includes with an optimization engine (e.g., the optimization engine 1124), as described herein.

At 1502, the server receives an input representing a new load via a graphical user interface displayed at a client device. This input includes details such as origin location, destination location, departure time range, and delivery time range. The user may input this information through interactive fields or forms on the interface. An example of the input is illustrated at region 1202 of FIG. 12.

At 1504, a formatting engine (e.g., the input formatting engine 1118) of the server transforms the input into new load data in a standardized load format. This transformation ensures that the new load data is consistent with existing data formats used by the system, facilitating seamless integration with the optimization processes.

At 1506, the optimization engine generates a new load-truck match by matching the new load to at least one truck based on the new load data, existing load-truck matches, and a set of global constraints (e.g., the global constraints 1116) stored in a constraint data repository (e.g., the constraint data repository 1108). The optimization engine may include a multilayered graph neural network, which is adept at handling complex relational data and constraints.

According to some implementations, generating the new load-truck match involves representing the existing load-truck matches as a graph data structure with nodes corresponding to individual loads and trucks, and edges representing potential matches between them. A new node corresponding to the new load data is created and added to this graph.

The optimization engine evaluates each new edge between the new load node and at least a subset of the truck nodes based on learned dependencies among features in the existing load-truck matches and the global constraints. These features may include truck availability, locations, capacities, and compliance requirements.

The optimization engine iteratively adjusts edge weights to optimize at least one numeric value by selecting at least one new edge and rejecting others. The numeric value could be revenue, cost, profit, carbon emissions, or mileage, aiming to find the most optimal match for the new load.

At 1508, the optimization engine generates an output of multiple new edges for manual review, providing information associated with each potential match. This output includes details that help the user assess the suitability of each candidate truck for the new load.

At 1510, the server transmits the output to the client device for display via the graphical user interface. The interface may present the candidate trucks as selectable elements, each displaying visual representations such as current location, availability status, expected route, and estimated cost. Alternatively, the candidates may be shown as rows in a table with columns for these attributes.

The graphical user interface may also include filtering options, allowing the user to narrow down the truck matches based on criteria like location, availability, route, or cost. Additionally, a map may be displayed highlighting roadways associated with the loads, providing a visual context for the matches.

At 1512, the server receives an indication from the client device of the user's selection of one of the multiple new edges or a rejection of all proposed matches. Based on this input, the server adjusts the set of load-truck matches stored in a match data repository (e.g., the match data repository 1114).

In some implementations, the server transmits a notification to a computing device (e.g., the truck computing device 1112) associated with the selected truck, informing the driver of the new load assignment. The server may also prompt for a confirmation of the assignment and, if confirmation is not received within a threshold time period, reassign the load to another truck.

The technique 1500 enhances the flexibility and efficiency of the logistics system by allowing users to interactively add new loads and select optimal truck matches. By integrating advanced optimization algorithms with user input, the system ensures that new loads are assigned in a manner that aligns with operational goals and constraints.

In an example use case, a freight coordinator at a logistics company receives an urgent request from a customer to transport a new load of goods from Los Angeles to Chicago within a specific delivery window. The coordinator needs to integrate this new load into the company's existing schedule of load-truck matches without disrupting current operations.

The coordinator accesses the company's logistics management system using a client device, such as a laptop or tablet. Through the graphical user interface displayed on the device, the coordinator inputs the details of the new load. This input includes the origin location (Los Angeles), destination location (Chicago), departure time range, delivery time range, load type, weight, and any special handling requirements.

The server's formatting engine processes this input by transforming it into new load data in a standardized load format. This standardization ensures that the new load data is compatible with the existing data structures used by the optimization engine, facilitating seamless integration into the optimization process.

The server's optimization engine begins generating potential matches between the new load and available trucks. The optimization engine utilizes a multilayered graph neural network to model complex relationships and constraints. It represents the existing load-truck matches as a graph data structure, where nodes correspond to individual loads and trucks, and edges represent potential matches. A new node representing the new load is added to this graph.

The optimization engine evaluates new edges between the new load node and nodes representing candidate trucks. It assesses these potential matches based on learned dependencies among features in the existing load-truck matches and a set of global constraints stored in a constraint data repository. These features include truck availability, current locations, capacity, driver qualifications, route compatibility, and compliance with regulations.

The engine iteratively adjusts the weights of these edges to optimize a specific numeric value, such as minimizing total transit time or maximizing profit margins. It selects the most promising edges (potential matches) while rejecting less optimal ones, aiming to find the best truck or trucks to carry the new load without adversely affecting existing assignments.

The optimization engine generates an output comprising multiple potential load-truck matches for the new load. Each potential match includes detailed information such as the truck's current location, estimated time of arrival at the pickup point, capacity, driver availability, estimated cost, and any potential impacts on existing schedules.

The server then transmits this output to the coordinator's client device for display via the graphical user interface. The graphical user interface presents the candidate trucks as selectable elements, for example, as a list or table, each accompanied by key attributes to aid in decision-making. For instance, each row in the table might display the truck's identification number, current location, distance from Los Angeles, availability status, estimated cost for transporting the load, and any additional notes.

To facilitate efficient evaluation, the graphical user interface may include filtering and sorting options. The coordinator can filter the list based on criteria such as trucks within a 100-mile radius of Los Angeles, those available within the required pickup window, or those offering the lowest transportation costs. A map interface might also be provided, visually displaying the locations of candidate trucks relative to the pickup point and highlighting their potential routes.

After reviewing the options, the coordinator selects the most suitable truck for the new load. This selection might be based on factors like proximity to the pickup location, cost-effectiveness, driver availability, and minimal disruption to existing schedules. Alternatively, if none of the presented options are satisfactory, the coordinator might reject all suggested matches, prompting the system to reevaluate with adjusted parameters or to consider external carrier options.

Upon receiving the coordinator's selection, the server adjusts the existing set of load-truck matches stored in the match data repository. It updates the assignments to include the new load-truck match and recalculates any affected schedules or routes to ensure continued optimization across the entire operation.

The server may send a notification to a computing device associated with a driver of the selected truck, informing the driver of the new assignment. The driver might receive details such as pickup and delivery locations, time windows, load specifics, and any special instructions. The server may request confirmation from the driver to ensure they can accommodate the new load. If confirmation is not received within a predefined time window, the server may automatically reassign the load to another suitable truck to prevent delays. The reassignment may be done using the optimization engine 1124 and based on the load data 1120 and the truck data 1122. For example, the reassignment may be done by applying the optimization engine 1124 to the load data 1120 and to a modified version of the truck data 1122 lacking the truck that was originally assigned to the load.

This example demonstrates how the system enables dynamic integration of new loads into existing logistics operations. By leveraging advanced optimization algorithms and providing an interactive interface for manual review, the company can efficiently accommodate customer requests while maintaining optimal resource utilization and adherence to operational constraints.

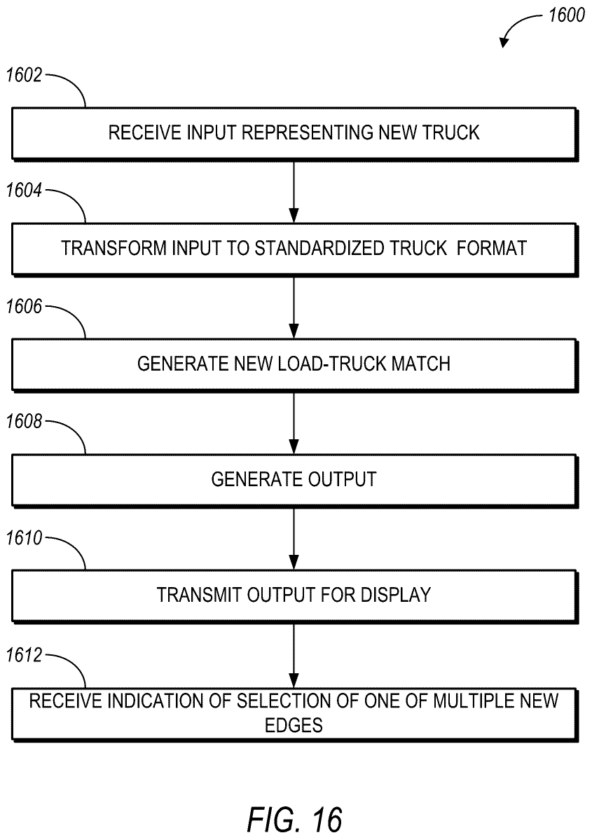

FIG. 16 is a flowchart of an example technique 1600 for updating a dispatch platform, in accordance with some embodiments. Updating the dispatch platform may include adding a new truck to an existing set of load-truck matches. The technique 1600 can be executed using computing devices, such as the systems, hardware, and software described with respect to FIGS. 1-13. The technique 1600 can be performed by executing machine-readable instructions, routines, or programs. The steps or operations of the technique 1600, or another technique, process, or algorithm described in connection with the implementations disclosed herein, can be implemented directly in hardware, firmware, software executed by hardware, circuitry, or a combination thereof. The technique 1600 can be implemented by a server (e.g., the server 1106) that communicates with client devices and includes with an optimization engine (e.g., the optimization engine 1124), as described herein.

At 1602, the server receives input representing a new truck for addition to a set of load-truck matches stored in a match data repository. This input is received via a graphical user interface displayed at a client device operated by a user, such as a dispatcher or logistics manager. The input includes at least one of an origin location, a destination location, a departure time range, or a delivery time range, which provides information about the truck's availability and scheduling preferences.

At 1604, the server transforms the input into new truck data in a standardized truck format. This transformation is performed by a formatting engine (e.g., the input formatting engine 1118) of the server, ensuring that the data conforms to a standard format used by the optimization engine. Standardization facilitates consistent processing and matching with loads in the system, allowing for efficient data handling and interoperability.

At 1606, the server generates a new load-truck match by matching the new truck to at least one load based on the new truck data, the existing set of load-truck matches, and a set of global constraints stored in a constraint data repository. The optimization engine comprises a multilayered graph neural network, which leverages machine learning techniques to optimize the matching process by learning complex dependencies and patterns in the data.

Generating the load-truck matches involves representing the set of load-truck matches as a graph data structure with nodes corresponding to individual loads and trucks, and edges representing potential matches between them. A new node corresponding to the new truck data is added to this graph. The optimization engine evaluates each new edge between the new truck node and at least a subset of the load nodes based on learned dependencies among features in the existing load-truck matches and the global constraints. It iteratively adjusts edge weights to optimize at least one numeric value, such as cost efficiency or delivery time, by selecting at least one new edge and rejecting others.

At 1608, the server generates an output of multiple new edges for manual review. This output includes information associated with each potential match, such as estimated costs, delivery times, and route details. Presenting multiple options allows users to exercise discretion and make informed decisions based on additional factors that may not be captured by the optimization engine.

At 1610, the server transmits the output to the client device for display via the graphical user interface. The client device displays the potential matches, enabling the user to review and compare the options. This interaction facilitates collaboration between automated optimization and human expertise, enhancing the overall decision-making process (claim 1).

In some implementations, transmitting the output to the client device includes causing the client device to display indicia of a plurality of candidate loads for the new truck as selectable elements. Each selectable element may include a visual representation of at least one of a current location of a corresponding load, an availability status, an expected route, or estimated cost. This provides an intuitive interface for users to assess and select the most suitable matches.

In some implementations, the client device may display the candidate loads as rows in a table, with each row corresponding to a step in a proposed trajectory of the new truck. This tabular format helps users visualize the sequence of loads and plan the truck's route effectively. In some cases, a map of the proposed trajectory of the new truck may be presented along with the table, for example, as shown in FIG. 13.

Some implementations may include a filtering interface on the client device for refining load matches based on criteria such as current location, availability status, expected route, or estimated cost. This allows users to narrow down options according to specific needs or preferences.

In some cases, the client device may display a map indicating a proposed path for the new truck, providing a visual representation of the route and assisting the user in assessing the practicality and efficiency of potential matches.

At 1612, the server receives an indication of a selection of one of the multiple new edges or a rejection of the new edges from the client device. Based on this indication, the server adjusts the set of load-truck matches stored in the match data repository. If a match is selected, it is added to the repository; if rejected, the system may continue searching or prompt for new input, ensuring that the load assignment process remains dynamic and responsive.

In some implementations, the server transmits a notification of the matched load to a computing device associated with the new truck, such as the driver's mobile device or an onboard computer. This keeps the driver informed of their assignments and allows for real-time updates.

The server may also prompt the driver for confirmation of the assigned load. If confirmation is not received within a threshold time period (e.g., two hours, twelve hours, or one day), the server may reassign the load to another truck, thereby maintaining operational efficiency and minimizing delays in the logistics network. In some cases, the threshold time period may be determined based on a time when an earliest load in the assigned loads is to be picked up. For example, if the earliest load is to be picked up within six hours, the threshold time period may be 30 minutes, to ensure that a reassignment is possible if the driver does not quickly provide an acknowledgement. If the earliest load is to be picked up within the next two weeks, the driver may be given 24 hours to respond. The reassignment may be done using the optimization engine 1124 and based on the load data 1120 and the truck data 1122. For example, the reassignment may be done by applying the optimization engine 1124 to the load data 1120 and to a modified version of the truck data 1122 lacking the truck that was originally assigned to the load.

Some implementations relate to a tool that optimizes for an additional load (e.g., as illustrated in FIG. 15). Some implementations use engines to recommend multiple sequences of loads (plans) for an additional truck (e.g., as illustrated in FIG. 16). Assume that there are several optional loads available e.g. from load boards or from broker companies, and a carrier company wants to book loads for one of its trucks hauling from point A to point B between time T1 and T2. The disclosed engines look into the available loads and creates multiple plans that result in an optimization of at least one of maximum revenue, maximum mileage, minimum empty miles (deadhead) between loads, and/or minimum idle time. One of the plans, in which a truck that is currently (e.g., immediately before September 1, 9:00 am) located at point A is to be delivered to point B (e.g., by September 5, 4:00 pm) may correspond to the plan illustrated in Table 1.

TABLE 1
Example plan for a truck

| Start time | End time | Description |
|---|---|---|
| Sep. 1, 9:00 am | Sep. 2, 9:00 am | Deadhead from A to C |
| Sep. 2, 9:00 am | Sep. 3, 5:00 pm | Pickup load 1 from C |
| | | and drop in D |
| Sep. 3, 5:00 pm | Sep. 4, 12:00 pm | Deadhead from D to E |
| Sep. 4, 12:00 pm | Sep. 4, 6:00 pm | Pickup load 2 from E |
| | | and drop in F |
| Sep. 4, 6:00 pm | Sep. 5, 11:00 am | Deadhead from F to G |
| Sep. 5, 11:00 am | Sep. 5, 4:00 pm | Pickup load 3 from G |
| | | and drop in B |

In an example use case involving a freight logistics platform, a transportation company aims to optimize the assignment of available trucks to shipping loads efficiently. A logistics coordinator at the company uses a client device equipped with a GUI to input details about a newly available truck. The truck is currently located in Atlanta, Georgia, and is available to depart between November 5 and November 7. The coordinator specifies the truck's desired destination as Dallas, Texas, and includes a preferred delivery time range.

Upon receiving this input through the GUI, the server's formatting engine processes the information and converts it into a standardized truck data format recognized by the system. This standardized data ensures consistency and compatibility within the platform's internal processes.

The server then utilizes a multilayered graph neural network to generate potential matches between the new truck and available shipping loads. The neural network constructs a graph data structure where nodes represent individual trucks and loads. Edges between these nodes symbolize potential matches based on various factors such as location proximity, time windows, load requirements, and vehicle capacity.

A new node representing the newly inputted truck is added to this graph. The neural network evaluates potential edges—that is, possible matches—between this new truck node and nodes representing available loads. This evaluation considers learned dependencies from historical load-truck match data and adheres to global constraints stored in a constraint data repository, such as legal regulations, company policies, and operational limitations.

Through an iterative process, the neural network adjusts the weights of the edges to optimize specific numeric values, such as minimizing transit time or maximizing revenue. This optimization involves selecting the most suitable edges (potential matches) while rejecting less favorable ones based on the defined criteria.

After completing the optimization, the server generates an output consisting of multiple potential load matches for the new truck. This output includes detailed information associated with each potential match, such as the load's characteristics, pick-up and delivery locations, required delivery times, and estimated earnings. The server transmits this information back to the logistics coordinator's client device for manual review via the GUI.

The logistics coordinator reviews the proposed matches displayed on the GUI. After considering factors like profitability, route efficiency, and driver preferences, the coordinator selects one of the potential matches or opts to reject all if none are suitable. The server receives this selection and updates the set of load-truck matches stored in the match data repository accordingly, finalizing the assignment or leaving the truck available for future matching opportunities.

In this way, the system efficiently transforms the coordinator's input about a new truck into optimized load assignment options by leveraging advanced neural network algorithms and data-driven decision-making processes, ultimately enhancing operational efficiency within the logistics network.

Some implementations relate to a platform that simplifies the assignment of available trucks to shipping loads. When a new truck is ready, a user inputs basic details, such as where it's coming from, where it's going, and timing. The disclosed system then analyzes this information along with existing schedules and company rules to find the best load matches. It presents the user with several optimal options to choose from, allowing the user to select the most suitable match. This process enhances efficiency, ensures better utilization of resources, and helps the logistics operation run more smoothly.

In connection with FIGS. 3-4, a detailed use case may highlight how machine learning-based image recognition, as illustrated in these figures, can enhance the performance and capabilities of the claimed dispatch platform. Specifically, FIG. 3, which demonstrates the training process for an image recognition machine learning program, can be applied to dynamically analyze and categorize data associated with trucks and loads. For example, by incorporating image recognition algorithms, the dispatch platform could classify incoming load requests based on load type, size, or other visual attributes, improving the assignment of trucks to loads by ensuring compatibility. Moreover, image recognition capabilities could assist in verifying truck readiness by automatically inspecting images for wear, load configurations, or compliance with regulatory standards.

Additionally, the CNN of FIG. 4 may be leveraged to process complex data in real-time, particularly within a dynamic dispatch environment. For instance, the CNN could be applied to monitor real-time road and traffic data, adjusting routes based on predicted congestion patterns. This approach would not only enhance the accuracy of truck-load matching but also optimize route planning by identifying the most efficient paths while accounting for varying conditions. By processing large amounts of visual data, the CNN could assist the dispatch platform in recognizing trends in load and route demands, potentially informing future predictive models that anticipate peak demand times, preferred routes, and load categories.

In another potential use case, the machine learning architecture of FIGS. 3-4 could support driver and fleet management by evaluating driver performance metrics derived from vehicle data, such as images capturing road behavior or vehicle condition. These models could help classify driver behaviors in terms of safety and efficiency, using image or sensor-based data to analyze braking patterns, acceleration rates, and route adherence. Such analysis could be used to provide feedback to drivers, ensuring alignment with safety and efficiency standards, while enabling carriers to make informed decisions about driver assignments for specific load types or routes, based on historical data and current route conditions.

Further, machine learning techniques, such as those depicted in FIGS. 3-4, may enable the dispatch platform to integrate predictive maintenance and fleet diagnostics. By utilizing image recognition to assess truck conditions at loading or unloading points, the platform could predict potential mechanical issues before they lead to breakdowns. For example, visual inspection data from trucks could be analyzed by a neural network to detect signs of tire wear, fluid leaks, or structural anomalies, leading to preemptive maintenance recommendations. This integration of machine learning in maintenance may decrease downtime, optimize fleet utilization, and reduce costs, all while supporting seamless operational continuity in the dispatch system.

Some implementations are described in conjunction with trucks. However, it should be noted that the disclosed technology may be implemented with vehicles other than trucks. For example, the disclosed technology may be implemented with cargo ships, passenger ships, trains, airplanes, buses, taxis, passenger cars, bicycles, pedestrians, or animals (e.g., horses or dogs) carrying loads, as disclosed herein. Unless explicitly stated otherwise, a “truck” as recited in this description may be replaced with any other vehicle. The disclosed techniques are not limited to being implemented with trucks and may be implemented with other vehicles or non-vehicular moving things.

Some implementations are described in conjunction with loads. However, the disclosed technology may be implemented with things other than loads that are carried by trucks or other vehicles. For example, loads may be replaced with passengers (e.g., on a taxi, a bus, or a train) or other things. In some implementations, loads may include at least one of less-than-a-truck loads, multi-modal shipments, international freight shipments, and drayage freight loads.

Some embodiments are described as numbered examples (Example 1, 2, 3, etc.). These are provided as examples only and do not limit the technology disclosed herein.

Example 1 is a method comprising: transforming, by an input formatting engine of a server, load data from a plurality of load data sources into a standardized load format; transforming, by the input formatting engine, truck data from a plurality of truck data sources into a standardized truck format; obtaining, by a multilayered graph neural network of the server, the load data in the standardized load format and the truck data in the standardized truck format; generating, by the multilayered graph neural network, load-truck matches matching at least one load to at least one truck based on the load data, the truck data, and a set of global constraints stored in a constraint data repository; transforming, by a match formatting engine, the load-truck matches into a match format for storage in a match data repository; and transmitting, by the server, the load-truck matches in the match format to the match data repository.

In Example 2, the subject matter of Example 1 includes, wherein generating the load-truck matches comprises: generating a graph data structure representing the load data and the truck data, the graph data structure comprising nodes corresponding to individual loads and trucks, and edges representing potential matches between loads and trucks; evaluating each edge based on learned dependencies among features in the load data, the truck data, and the global constraints; and iteratively adjusting edge weights to optimize at least one numeric value by selecting a first subset of the edges and rejecting a second subset of the edges, wherein the first subset and the second subset are mutually exclusive and collectively exhaustive.

In Example 3, the subject matter of Examples 1-2 includes, causing display, at a client device communicating with the server, of a graphical user interface representing the load-truck matches, wherein the graphical user interface comprises a dashboard layout that includes multiple interactive panels displaying key performance indicators related to at least one of the load-truck matches, wherein the key performance indicators comprise at least one of: a profit, a revenue per mile, a fuel cost, a mileage travelled, or a deadhead percentage.

In Example 4, the subject matter of Examples 1-3 includes, causing display, at a client device communicating with the server, of a graphical user interface representing the load-truck matches, wherein the graphical user interface comprises a visual map interface that graphically represents a route associated with at least one load-truck match, the visual map interface including at least one of: an origin location, a destination location, a route path, or an estimated travel time, the visual map interface comprising a visually indicated line to indicate a status of at least one route segment.

In Example 5, the subject matter of Examples 1-4 includes, causing display, at a client device communicating with the server, of a graphical user interface representing the load-truck matches, wherein the graphical user interface comprises a filter and search toolbar, the filter and search toolbar enabling a user of the client device to sort and filter load-truck matches based on criteria, the criteria comprising at least one of a distance, driver availability, compliance status, or load type.

In Example 6, the subject matter of Examples 1-5 includes, causing display, at a client device communicating with the server, of a graphical user interface representing the load-truck matches, wherein the graphical user interface comprises a load-truck matching matrix indicating the load-truck matches in cell of the matrix; receiving, from the client device, an indication of a selection of a cell of the matrix; causing display, at the client device and in response to the indication of the selection, of additional data related to a load-truck match of the cell.

In Example 7, the subject matter of Examples 1-6 includes, causing display, at a client device communicating with the server, of a graphical user interface representing the load-truck matches, wherein the graphical user interface comprises a dashboard comprising at least one graph indicating at least one of a truck utilization rate, a mileage rate, a profit rate, a revenue rate, or a match rate of loads to trucks.

In Example 8, the subject matter of Examples 1-7 includes, causing display, at a client device communicating with the server, of a graphical user interface representing the load-truck matches, wherein the graphical user interface comprises a truck view interface indicating loads assigned to at least one truck; and transmitting, to a computing device associated with the at least one truck, an indication the loads assigned to the at least one truck and a proposed route for the at least one truck.

In Example 9, the subject matter of Examples 1-8 includes, causing display, at a client device communicating with the server, of a graphical user interface representing the load-truck matches, wherein the graphical user interface comprises a modification interface for a user of the client device to manually assign a first load to a first truck or to manually remove an assignment of a second load to a second truck.

In Example 10, the subject matter of Examples 1-9 includes, wherein the features comprise at least one of a load location, a truck location, a load departure time range, a load delivery time range, a truck location constraint, a revenue potential, or a compliance constraint of the global constraints.

In Example 11, the subject matter of Examples 1-10 includes, wherein the at least one numeric value comprises or is determined based on at least one of a revenue value, a cost value, a profit value, a carbon emission value, or a mileage value.

In Example 12, the subject matter of Examples 1-11 includes, wherein the load data comprises a first set of mandatory loads and a second set of optional loads, wherein the load-truck matches include the first set of mandatory loads and a subset of the second set of optional loads.

In Example 13, the subject matter of Examples 1-12 includes, wherein the multilayered graph neural network comprises at least one input layer, one or more hidden layers, and an output layer, wherein: the input layer receives node features representing attributes of loads from the load data and attributes of trucks from the truck data; the hidden layers perform graph convolutional operations that aggregate information from neighboring nodes and edges to capture relationships between loads and trucks; and the output layer generates a matching score for each load-truck pairing based on the aggregated node and edge features, the load-truck matches being generated based on the matching score.

In Example 14, the subject matter of Examples 1-13 includes, wherein the multilayered graph neural network is configured to iteratively adjust the edge weights by: using a message-passing sub-engine to transmit information between connected nodes, allowing each node to update its state based on a state of a neighboring node or an attribute of an edge connecting to the node, and using a gradient-based optimization sub-engine to adjust weights of the edges based on optimizing the at least one numeric value.

Example 15 is a non-transitory computer-readable medium storing instructions operable to cause one or more processors to perform operations comprising: transforming, by an input formatting engine of a server, load data from a plurality of load data sources into a standardized load format; transforming, by the input formatting engine, truck data from a plurality of truck data sources into a standardized truck format; obtaining, by a multilayered graph neural network of the server, the load data in the standardized load format and the truck data in the standardized truck format; generating, by the multilayered graph neural network, load-truck matches matching at least one load to at least one truck based on the load data, the truck data, and a set of global constraints stored in a constraint data repository; transforming, by a match formatting engine, the load-truck matches into a match format for storage in a match data repository; and transmitting, by the server, the load-truck matches in the match format to the match data repository.

In Example 16, the subject matter of Example 15 includes, wherein generating the load-truck matches comprises: generating a graph data structure representing the load data and the truck data, the graph data structure comprising nodes corresponding to individual loads and trucks, and edges representing potential matches between loads and trucks; evaluating each edge based on learned dependencies among features in the load data, the truck data, and the global constraints; and iteratively adjusting edge weights to optimize at least one numeric value by selecting a first subset of the edges and rejecting a second subset of the edges, wherein the first subset and the second subset are mutually exclusive and collectively exhaustive.

In Example 17, the subject matter of Examples 15-16 includes, the operations further comprising: causing display, at a client device communicating with the server, of a graphical user interface representing the load-truck matches, wherein the graphical user interface comprises a dashboard layout that includes multiple interactive panels displaying key performance indicators related to at least one of the load-truck matches, wherein the key performance indicators comprise at least one of: a profit, a revenue per mile, a fuel cost, a mileage travelled, or a deadhead percentage.

Example 18 is a system, comprising: a memory subsystem storing instructions; and processing circuitry configured to execute the instructions to: transform, by an input formatting engine of a server, load data from a plurality of load data sources into a standardized load format; transform, by the input formatting engine, truck data from a plurality of truck data sources into a standardized truck format; obtain, by a multilayered graph neural network of the server, the load data in the standardized load format and the truck data in the standardized truck format; generate, by the multilayered graph neural network, load-truck matches matching at least one load to at least one truck based on the load data, the truck data, and a set of global constraints stored in a constraint data repository; transform, by a match formatting engine, the load-truck matches into a match format for storage in a match data repository; and transmit, by the server, the load-truck matches in the match format to the match data repository.

In Example 19, the subject matter of Example 18 includes, the processing circuitry further configured to execute the instructions to: cause display, at a client device communicating with the server, of a graphical user interface representing the load-truck matches, wherein the graphical user interface comprises a dashboard layout that includes multiple interactive panels displaying key performance indicators related to at least one of the load-truck matches, wherein the key performance indicators comprise at least one of: a profit, a revenue per mile, a fuel cost, a mileage travelled, or a deadhead percentage.

In Example 20, the subject matter of Examples 18-19 includes, the processing circuitry further configured to execute the instructions to: cause display, at a client device communicating with the server, of a graphical user interface representing the load-truck matches, wherein the graphical user interface comprises a visual map interface that graphically represents a route associated with at least one load-truck match, the visual map interface including at least one of: an origin location, a destination location, a route path, or an estimated travel time, the visual map interface comprising a visually indicated line to indicate a status of at least one route segment.

Example 21 is a method comprising: receiving, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range; transforming, by a formatting engine of the server, the input into new truck data in a standardized truck format; generating, by a multilayered graph neural network of the server, a new load-truck match matching the new truck to at least one load based on the new truck data, the set of load-truck matches, and a set of global constraints stored in a constraint data repository; generating an output of multiple new edges for manual review, the output indicating information associated with each of the multiple new edges; transmitting the output to the client device for display via the graphical user interface; receiving, from the client device, an indication of a selection of one of the multiple new edges or a rejection of the new edges; and adjusting, by the server, the set of load-truck matches stored in a match data repository based on the indication.

In Example 22, the subject matter of Example 21 includes, wherein generating the load-truck matches comprises: generating a graph data structure representing the set of load-truck matches, the graph data structure comprising nodes corresponding to individual loads and trucks, and edges representing potential matches between loads and trucks; generating a new node corresponding to the new truck data; evaluating each new edge between at least a subset of the nodes representing loads and the new node based on learned dependencies among features in the set of load-truck matches and the global constraints; and iteratively adjusting edge weights to optimize at least one numeric value by selecting at least one new edge and rejecting other new edges.

In Example 23, the subject matter of Examples 21-22 includes, wherein transmitting the output to the client device for display via the graphical user interface comprises: causing the client device to display indicia of a plurality of candidate loads for the new truck as selectable elements, each selectable element including a visual representation of at least one of: a current location of a corresponding load, an availability status of the corresponding load, an expected route, or an estimated cost.

In Example 24, the subject matter of Examples 21-23 includes, wherein transmitting the output to the client device for display via the graphical user interface comprises: causing the client device to display indicia of a plurality of candidate loads for the new truck as rows in a table, the table comprising rows corresponding to steps in a proposed trajectory of the new truck.

In Example 25, the subject matter of Examples 21-24 includes, wherein transmitting the output to the client device for display via the graphical user interface comprises: causing the client device to display a filtering interface for filtering load matches for the new truck based on at least one of: a current location of a candidate load, an availability status of the candidate load, an expected route, or an estimated cost.

In Example 26, the subject matter of Examples 21-25 includes, wherein transmitting the output to the client device for display via the graphical user interface comprises: causing the client device to display a map indicating a proposed path for the new truck.

In Example 27, the subject matter of Examples 21-26 includes, transmitting, to a computing device associated with the new truck, a notification of the at least one load matched to the new truck.

In Example 28, the subject matter of Example 27 includes, transmitting, to the computing device, a prompt for a confirmation of the at least one load; and reassigning, by applying the multilayered graph neural network to stored load data and stored truck data, the at least one load to another truck upon failing to receive the confirmation during a threshold time period.

Example 29 is a non-transitory computer-readable medium storing instructions operable to cause one or more processors to perform operations comprising: receiving, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range; transforming, by a formatting engine of the server, the input into new truck data in a standardized truck format; generating, by a multilayered graph neural network of the server, a new load-truck match matching the new truck to at least one load based on the new truck data, the set of load-truck matches, and a set of global constraints stored in a constraint data repository; generating an output of multiple new edges for manual review, the output indicating information associated with each of the multiple new edges; transmitting the output to the client device for display via the graphical user interface; receiving, from the client device, an indication of a selection of one of the multiple new edges or a rejection of the new edges; and adjusting, by the server, the set of load-truck matches stored in a match data repository based on the indication.

In Example 30, the subject matter of Example 29 includes, wherein generating the load-truck matches comprises: generating a graph data structure representing the set of load-truck matches, the graph data structure comprising nodes corresponding to individual loads and trucks, and edges representing potential matches between loads and trucks; generating a new node corresponding to the new truck data; evaluating each new edge between at least a subset of the nodes representing loads and the new node based on learned dependencies among features in the set of load-truck matches and the global constraints; and iteratively adjusting edge weights to optimize at least one numeric value by selecting at least one new edge and rejecting other new edges.

In Example 31, the subject matter of Examples 29-30 includes, wherein transmitting the output to the client device for display via the graphical user interface comprises: causing the client device to display indicia of a plurality of candidate loads for the new truck as selectable elements, each selectable element including a visual representation of at least one of: a current location of a corresponding load, an availability status of the corresponding load, an expected route, or an estimated cost.

In Example 32, the subject matter of Examples 29-31 includes, wherein transmitting the output to the client device for display via the graphical user interface comprises: causing the client device to display indicia of a plurality of candidate loads for the new truck as rows in a table, the table comprising rows corresponding to steps in a proposed trajectory of the new truck.

In Example 33, the subject matter of Examples 29-32 includes, wherein transmitting the output to the client device for display via the graphical user interface comprises: causing the client device to display a filtering interface for filtering load matches for the new truck based on at least one of: a current location of a candidate load, an availability status of the candidate load, an expected route, or an estimated cost.

In Example 34, the subject matter of Examples 29-33 includes, wherein transmitting the output to the client device for display via the graphical user interface comprises: causing the client device to display a map indicating a proposed path for the new truck.

In Example 35, the subject matter of Examples 29-34 includes, the operations further comprising: transmitting, to a computing device associated with the new truck, a notification of the at least one load matched to the new truck.

In Example 36, the subject matter of Example 35 includes, the operations further comprising: transmitting, to the computing device, a prompt for a confirmation of the at least one load; and reassigning, by applying the multilayered graph neural network to stored load data and stored truck data, the at least one load to another truck upon failing to receive the confirmation during a threshold time period.

Example 37 is a system, comprising: a memory subsystem storing instructions; and processing circuitry configured to execute the instructions to: receive, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range; transform, by a formatting engine of the server, the input into new truck data in a standardized truck format; generate, by a multilayered graph neural network of the server, a new load-truck match matching the new truck to at least one load based on the new truck data, the set of load-truck matches, and a set of global constraints stored in a constraint data repository; generate an output of multiple new edges for manual review, the output indicating information associated with each of the multiple new edges; transmit the output to the client device for display via the graphical user interface; receive, from the client device, an indication of a selection of one of the multiple new edges or a rejection of the new edges; and adjust, by the server, the set of load-truck matches stored in a match data repository based on the indication.

In Example 38, the subject matter of Example 37 includes, wherein transmitting the output to the client device for display via the graphical user interface comprises: causing the client device to display indicia of a plurality of candidate loads for the new truck as selectable elements, each selectable element including a visual representation of at least one of: a current location of a corresponding load, an availability status of the corresponding load, an expected route, or an estimated cost.

In Example 39, the subject matter of Examples 37-38 includes, wherein transmitting the output to the client device for display via the graphical user interface comprises: causing the client device to display indicia of a plurality of candidate loads for the new truck as rows in a table, the table comprising rows corresponding to steps in a proposed trajectory of the new truck.

In Example 40, the subject matter of Examples 37-39 includes, wherein transmitting the output to the client device for display via the graphical user interface comprises: causing the client device to display a filtering interface for filtering load matches for the new truck based on at least one of: a current location of a candidate load, an availability status of the candidate load, an expected route, or an estimated cost.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range;
transforming, by a formatting engine of the server, the input into new truck data in a standardized truck format;
generating, by a multilayered graph neural network of the server, a new load-truck match matching the new truck to at least one load based on the new truck data, the set of load-truck matches, and a set of global constraints stored in a constraint data repository;
generating an output of multiple new edges for manual review, the output indicating information associated with each of the multiple new edges;
transmitting the output to the client device for display via the graphical user interface;
receiving, from the client device, an indication of a selection of one of the multiple new edges or a rejection of the new edges; and
adjusting, by the server, the set of load-truck matches stored in a match data repository based on the indication.

2. The method of claim 1, wherein generating the load-truck matches comprises:
generating a graph data structure representing the set of load-truck matches, the graph data structure comprising nodes corresponding to individual loads and trucks, and edges representing potential matches between loads and trucks;
generating a new node corresponding to the new truck data;
evaluating each new edge between at least a subset of the nodes representing loads and the new node based on learned dependencies among features in the set of load-truck matches and the global constraints; and
iteratively adjusting edge weights to optimize at least one numeric value by selecting at least one new edge and rejecting other new edges.

3. The method of claim 1, wherein transmitting the output to the client device for display via the graphical user interface comprises:
causing the client device to display indicia of a plurality of candidate loads for the new truck as selectable elements, each selectable element including a visual representation of at least one of: a current location of a corresponding load, an availability status of the corresponding load, an expected route, or an estimated cost.

4. The method of claim 1, wherein transmitting the output to the client device for display via the graphical user interface comprises:
causing the client device to display indicia of a plurality of candidate loads for the new truck as rows in a table, the table comprising rows corresponding to steps in a proposed trajectory of the new truck.

5. The method of claim 1, wherein transmitting the output to the client device for display via the graphical user interface comprises:
causing the client device to display a filtering interface for filtering load matches for the new truck based on at least one of: a current location of a candidate load, an availability status of the candidate load, an expected route, or an estimated cost.

6. The method of claim 1, wherein transmitting the output to the client device for display via the graphical user interface comprises:
causing the client device to display a map indicating a proposed path for the new truck.

7. The method of claim 1, further comprising:
transmitting, to a computing device associated with the new truck, a notification of the at least one load matched to the new truck.

8. The method of claim 7, further comprising:
transmitting, to the computing device, a prompt for a confirmation of the at least one load; and
reassigning, by applying the multilayered graph neural network to stored load data and stored truck data, the at least one load to another truck upon failing to receive the confirmation during a threshold time period.

9. A non-transitory computer-readable medium storing instructions operable to cause one or more processors to perform operations comprising:
receiving, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range;
transforming, by a formatting engine of the server, the input into new truck data in a standardized truck format;
generating, by a multilayered graph neural network of the server, a new load-truck match matching the new truck to at least one load based on the new truck data, the set of load-truck matches, and a set of global constraints stored in a constraint data repository;
generating an output of multiple new edges for manual review, the output indicating information associated with each of the multiple new edges;
transmitting the output to the client device for display via the graphical user interface;
receiving, from the client device, an indication of a selection of one of the multiple new edges or a rejection of the new edges; and
adjusting, by the server, the set of load-truck matches stored in a match data repository based on the indication.

10. The non-transitory computer-readable medium of claim 9, wherein generating the load-truck matches comprises:
generating a graph data structure representing the set of load-truck matches, the graph data structure comprising nodes corresponding to individual loads and trucks, and edges representing potential matches between loads and trucks;
generating a new node corresponding to the new truck data;
evaluating each new edge between at least a subset of the nodes representing loads and the new node based on learned dependencies among features in the set of load-truck matches and the global constraints; and
iteratively adjusting edge weights to optimize at least one numeric value by selecting at least one new edge and rejecting other new edges.

11. The non-transitory computer-readable medium of claim 9, wherein transmitting the output to the client device for display via the graphical user interface comprises:
causing the client device to display indicia of a plurality of candidate loads for the new truck as selectable elements, each selectable element including a visual representation of at least one of: a current location of a corresponding load, an availability status of the corresponding load, an expected route, or an estimated cost.

12. The non-transitory computer-readable medium of claim 9, wherein transmitting the output to the client device for display via the graphical user interface comprises:
causing the client device to display indicia of a plurality of candidate loads for the new truck as rows in a table, the table comprising rows corresponding to steps in a proposed trajectory of the new truck.

13. The non-transitory computer-readable medium of claim 9, wherein transmitting the output to the client device for display via the graphical user interface comprises:
causing the client device to display a filtering interface for filtering load matches for the new truck based on at least one of: a current location of a candidate load, an availability status of the candidate load, an expected route, or an estimated cost.

14. The non-transitory computer-readable medium of claim 9, wherein transmitting the output to the client device for display via the graphical user interface comprises:
causing the client device to display a map indicating a proposed path for the new truck.

15. The non-transitory computer-readable medium of claim 9, the operations further comprising:
transmitting, to a computing device associated with the new truck, a notification of the at least one load matched to the new truck.

16. The non-transitory computer-readable medium of claim 15, the operations further comprising:
transmitting, to the computing device, a prompt for a confirmation of the at least one load; and
reassigning, by applying the multilayered graph neural network to stored load data and stored truck data, the at least one load to another truck upon failing to receive the confirmation during a threshold time period.

17. A system, comprising:
a memory subsystem storing instructions; and
processing circuitry configured to execute the instructions to:
receive, by a server and via a graphical user interface displayed at a client device, an input representing a new truck for addition to a set of load-truck matches stored in a match data repository, wherein the input representing the new truck comprises at least one of: an origin location, a destination location, a departure time range, or a delivery time range;
transform, by a formatting engine of the server, the input into new truck data in a standardized truck format;
generate, by a multilayered graph neural network of the server, a new load-truck match matching the new truck to at least one load based on the new truck data, the set of load-truck matches, and a set of global constraints stored in a constraint data repository;
generate an output of multiple new edges for manual review, the output indicating information associated with each of the multiple new edges;
transmit the output to the client device for display via the graphical user interface;
receive, from the client device, an indication of a selection of one of the multiple new edges or a rejection of the new edges; and
adjust, by the server, the set of load-truck matches stored in a match data repository based on the indication.

18. The system of claim 17, wherein transmitting the output to the client device for display via the graphical user interface comprises:
causing the client device to display indicia of a plurality of candidate loads for the new truck as selectable elements, each selectable element including a visual representation of at least one of: a current location of a corresponding load, an availability status of the corresponding load, an expected route, or an estimated cost.

19. The system of claim 17, wherein transmitting the output to the client device for display via the graphical user interface comprises:
causing the client device to display indicia of a plurality of candidate loads for the new truck as rows in a table, the table comprising rows corresponding to steps in a proposed trajectory of the new truck.

20. The system of claim 17, wherein transmitting the output to the client device for display via the graphical user interface comprises:
causing the client device to display a filtering interface for filtering load matches for the new truck based on at least one of: a current location of a candidate load, an availability status of the candidate load, an expected route, or an estimated cost.
